(19) United States
(12) Patent Application Publication
(10) Pub. No.: US 2004/0095705 A1
(43) Pub. Date: May 20, 2004

(54) Plasma-to-electric power conversion

(76) Inventors: Randell L. Mills, Cranbury, NJ (US); Robert M. Mayo, Cranbury, NJ (US)

Correspondence Address: MANELLI DENISON & SELTER, 2000 M STREET NW SUITE 700, WASHINGTON, DC, 20036-3307, US

(21) Appl. No.: 10/319,460

(22) Filed: Nov. 27, 2002

Related U.S. Application Data
(60) Provisional application No. 60/361,337, filed on Mar. 5, 2002.
(60) Provisional application No. 60/365,176, filed on Mar. 19, 2002.
(60) Provisional application No. 60/333,534, filed on Nov. 28, 2001.

(51) Int. Cl. H01T 23/00

(52) U.S. Cl. 361/230

(57) ABSTRACT

This invention relates to technologies, including Direct E×B, Magnetohydrodynamic, and Plasmadynamic, for the conversion of plasma energy into electrical energy.

### CROSS REFERENCE TO RELATED APPLICATION

This application claims priority from U.S. provisional patent application serial No. 60/361,337, filed Mar. 5, 2002 and 60/365,176, filed Mar. 19, 2002, the complete disclosures of which are incorporated herein by reference.

### FIELD OF THE INVENTION

The invention described herein relates to methods of conversion of thermal energy in high temperature gases called plasmas directly into electrical energy. Magnetohydrodynamic, Plasmadynamic, and Direct E×B conversion are plasma-to-electric conversion technologies in the class with direct electrostatic conversion of plasma energy and could be used for the conversion to electricity of fusion and laboratory plasma energy including those of both low and high power density. The power converter technologies disclosed here comprise magnetic fields, which permit positive ions to be collected separate from electrons using at least one electrode to produce voltage with respect to at least one counter electrode connected through a load.

### BACKGROUND OF THE INVENTION

When heated by chemical reactions (chemically assisted plasma or CA-plasma), electrical means, or nuclear reactions (thermonuclear fusion plasmas) gases can achieve sufficient energy so as to attain a high degree of ionization. Such gases are called plasmas. High temperature plasmas possess a substantial inventory of energy stored in the thermal and/or kinetic components of plasma ions, electrons, and in some cases neutral gas particles in some weakly ionized plasmas. Since a large fraction of the energy in these plasmas may be stored as charged particle energy, high-efficiency, low-cost direct energy conversion may be possible, thus, avoiding a heat engine such as a turbine or a reformer-fuel-cell system. Methods and technologies to efficiently extract this particle energy and convert it to a more useful form have been investigated. A number of plasma energy conversion schemes have been previously studied including thermal steam cycle [R. G. Mills, Nuclear Fusion, 7(1967)223, D. L. Rose, Nuclear Fusion, 9(1969)183] or direct conversion of plasma charged particle kinetic to electric energy [G. H. Miley, Fusion Energy Conversion, American Nuclear Society, La Grange, Ill., 1976]. Whereas for CA-plasma cell devices in particular, possessing only weakly ionized and relatively cold plasmas, conversion methods more compatible with a fluid environment like magnetohydrodynamic (MHD) [R. M. Mayo, R. L. Mills, and M. Nansteel, On the Potential for Direct or MHD Conversion of Power from a Novel Plasma Source to Electricity for Microdistributed Power Applications, accepted in IEEE Transactions on Plasma Science, 2002] or plasmadynamic conversion (PDC) [R. M. Mayo and R. L. Mills, Direct Plasmadynamic Conversion of Plasma Thermal Power to Electricity, accepted in IEEE Transactions on Plasma Science, 2002] are required.

A number of conversion schemes have been studied in the four plus decades of controlled thermonuclear fusion research as applied to fusion plasmas. At high temperature (as that produced in the blanket material of high power D-T fusion reactor) a thermal steam cycle [R. G. Mills, Nucl. Fus., 7 (1967) 223; D. L. Rose, Nucl. Fus., 9 (1969) 183] is usually considered the most practical energy extraction means as the bulk (80%) of the energy release is in the form of chargless neutrons. Thermal steam cycles are robust, reliable, proven technologies, and are well established as the work horse of modem electrical power delivery. Yet, the conversion efficiency is limited and high coolant temperatures are required. As well, economies of scale tend to prohibit the use of steam cycles in small (few tens of kW or less), distributed power sources.

Direct conversion of plasma charged particle kinetic to electric energy [G. H. Miley, Fusion Energy Conversion, American Nuclear Society Pub., La Grange, Ill., 1976] may represent an attractive alternative to the steam cycle for at least several plasma systems of great interest including; a) the D-T fusion reactor (as a “topping” unit to extract the remaining 20% fusion energy in charged particles), b) advanced, a-neutronic fueled fusion reactors, and c) lower-power, non-fusion plasma cells. In fusion reactors, the fully ionized, high temperature (up to 10-15 keV) plasma energy may be readily extracted by direct, electrostatic means, thereby converting charged particle kinetic energy to electrostatic potential energy via decelerating electrodes. Whereas plasma cell devices, possessing only weakly ionized and cold plasmas, may require conversion methods more compatible with a fluid environment like MHD or plasmadynamic converters to extract stored energy.

Many of the technologies consider applicable to plasma-to-electric energy conversion may be loosely grouped into one of the following four broad categories. The invention disclosed herein concerns the application of Direct E×B, Magnetohydrodynamic, and Plasmadynamic conversion to plasma conditions relevant to plasma cell technologies.

1. Electrostatic Direct Converters: Electrostatic direct devices convert directed ion kinetic energy to electrical potential energy via an electrode (or set of electrodes) electrically biased to decelerate ions extant from the plasma source. The most well studied of such converter devices are the “venetian blind” [R. W. Moir and W. L. Barr, Nucl. Fus., 13 (1973) 35; R. W. Moir, Barr, et al., Direct Conversion of Plasma Energy to Electricity for Mirror Fusion Reactors, Proc. 5^{th} IAEA Conference on Plasma Physics and Controlled Nuclear Fusion Research, Japan, 1974, IAEA Pub., Vienna, 1975] and “periodic focused” [R. P. Freis, Nucl. Fus., 13 (1973) 247] converters. These devices appear to hold great promise as very efficient (80-90%) direct converters for large scale (on the order of 1000 MW) generating stations.

In these devices, plasma particles are electrostatically separated by charge before deceleration and collection at the electrodes. Separation incurs space charge limitations which are particularly troublesome for all but very high energy particles. Reasonable currents are achievable only at very high energy (several to 100s of keV). Particles of these energy levels are not present in appreciable numbers in plasma cells. Furthermore, to mitigate the effects of high heat loading [J. D. Lee, J. Nucl. Mater., 53 (1974) 76; R. W. Moir, et al., G. H., J. Nucl. Mater., 53 (1974) 86], such devices require plasma expansion and become quite large in linear scale (10s-100s of meters).

2. Electromagnetic Direct (Crossed Field or E×B Drift) Converters: The guiding center drift of charged particles in magnetic and crossed electric fields may be exploited to separate and collect charge without the necessity to do so electrostatically.

Space charge complications are thereby eliminated. Dimensions can often be reduced (for low power converters) by many orders (perhaps to the ion gyro-scale). Natural mating of the converter magnetic field to a guide field is a further advantage. As the devices extract particle energy perpendicular to the magnetic field, expansion may not be necessary and is often undesirable.

The performance characteristics of an idealized \overline{E}×\overline{B} converter which relies on the inertial difference between ions and electrons, is analyzed in the Description of the Invention section. Timofeev [A. V. Timofeev, Sov. J. Plasma Phys. 4 (1978) 464; V. M.

Glagolev and A. V. Timofeev, Plasma Phys. Rep., 19 (1994) 745] devised a high efficiency conversion device based on combined \overline{E}×\overline{B} and ∇\overline{B} drift collection. This particular device is again designed for high-power fusion energy conversion and is quite large in dimension, and requires expansion and end plug fields to prevent plasma leakage. In addition, collisions among energetic ions and neutral particles in a low power plasma cell will likely interrupt the drift trajectory required for efficient energy conversion. As an example, Ar⁺ ions in a 1 T field have a gyro-frequency of ω_{c}_{ᵢ}=2.4×10⁶'s⁻¹ and a collision frequency with neutral Ar atoms of vᵢₙ=6×10⁷ s⁻¹ at 40 eV, making the ion magnetization parameter Ωᵢ=ω_{c}_{ᵢ}/Vᵢₙ≈0.04 (for H⁺ ions Ωᵢ˜0.27 under the same conditions). Ions then are readily interrupted in their drift trajectory and will not reach the desired collection electrode in the \overline{B}x∇\overline{B} direction.

3. MHD Converter: MHD (magnetohydrodynamics) refers to that branch of plasma science dealing with the combined fluid and electrodynamic behavior of conducting fluids in the presence of a magnetic field. MHD phenomena are among the most well studied in all of plasma science [R. J. Goldston, and P. H. Rutherford, Introduction to Plasma Physics, IOP, London, 1995]. An important effect in MHD involves conducting fluid flowing at velocity \overline{u} in a direction across a magnetic field \overline{B}. This flow induces an electric field in a direction perpendicular to both the flow and magnetic field directions given by \overline{E}=−\overline{u}×\overline{B}. This electric field may be intercepted at the boundary of a plasma device by electrodes and exploited to drive electric current through an external load. Mechanical flow energy of the conducting fluid is then converted to electrical energy. In the presence of a load to complete the circuit, the density of electric current, j, is given by the plasma Ohm's law

\overline{J}=σ(\overline{E}+\overline{u}×\overline{B}) [1]

where σ is the plasma conductivity. Here the term \overline{u}×\overline{B} is referred to as the MHD electric field or MHD term in Ohm's law.

The performance of an MHD power conversion system is impacted strongly by the value of a attained in the plasma region of the MHD converter. As such, collisions among charge carriers (either with other charge carriers of opposite sign or with neutral gas atoms) play a crucial role. Collisions, however, are not as disruptive in MHD converters as they are in direct conversion. MHD converters operate on fluid plasmas where collisions are frequent and the trajectories of individual plasma particles are relatively unimportant. The conductivity is also affected strongly by the strength of applied magnetic field in plasma. A detailed discussion of this subject is presented in the MHD Converter section of the Description of the Invention section as applied to plasma cell class of plasma parameters.

Power conversion devices based on the MHD effect have been extensively studied [S. Way, Westinghouse Eng., 20 (1960) 105; M. Sakuntala, et al., J. Appl. Phys., 30 (1959) 1669; H. P. Pain and P. R. Smy, J. Fluid Mech., 10 (1961) 51; R. J. Rosa, Phys. Fluids, 4 (1961) 182; R. J. Rosa, J. Appl. Phys., 31 (1961) 735; C. Mannal and N. W. Mather, Eds., Engineering Aspects of Magnetohydrodynamics, Columbia University Press, NY, 1962] including MHD concepts to deliver AC power directly from the converter [R. B. Clark, et al., Brit. J. Appl., Phys., 14 (1963) 10; P. R. Smy, J. Appl. Phys., 32 (1961) 1946]. These prior studies have focused on high pressure, high density (near atmospheric or greater) plasmas generated in shock tubes or arc jets for high power electric generation. Little effort has been made in studying MHD conversion in hotter, more tenuous plasmas for low power applications. The results outlined in the MHD Converter section are intended to disclose the invention whereby MHD may be applied to plasma cell devices.

4. Plasmadynamic Converter: The plasmadynamic converter is a class of conversion devices that directly generates electrical energy from plasma random thermal energy rather than from flow energy as in MHD. One technique [I. Alexeff, and D. W. Jones, Phys. Rev. Lett., 15 (1965) 286] involves immersing converter electrodes directly into the main plasma cell. One of the two electrodes is shrouded by a strong axial magnetic field. This field is made strong so that electrons are magnetized, but ions are not (the “ion slip” condition). This applied field prevents electrons from reaching the magnetized electrode while ions are free to flow and are collected. The other electrode being field free, favors electron collection. Such an arrangement of electrodes can supply the potential difference for power conversion. Because of the apparent simplicity, robustness, compactness, and in-situ operation without flow, plasmadynamic conversion applied to plasma cell technologies hold great promisse for power conversion, and therefore is the subject of disclosure in the Plasmadynamic converter section of the Description of the Invention section.

In this disclosure, the invention of Direct E×B and Magnetohydrodynamic (MHD) as applied to plasma cells is provided by means of a theoretical study of performance. The invention of plasmadynamic conversion (PDC) of plasma thermal to electrical energy for plasma cell devices using glow discharge and microwave plasma cells as test beds for the conversion process is demonstrated both theoretically and experimentally. As with MHD conversion, PDC extracts stored plasma energy directly. Unlike MHD, however, PDC does not require plasma flow. Instead, power extraction by PDC exploits the potential difference established between a magnetized and an unmagnetized electrode [I. Alexeff and D. W. Jones, Phys. Rev. Lett., 15(1965)286] immersed in a plasma to drive current in an external load and, thereby, extract electrical power directly from the stored plasma thermal energy. By the presentation of data shown herein, we demonstrate for the first time, a substantial quantity of electrical power extracted (˜2 W) by this technique. Furthermore, power scale-up to commercially appropriate power levels is shown to be achievable. The engineering relationships learned from these simulation studies can be applied to converting the thermal power from plasma cells or other plasma systems to electrical power.

### SUMMARY OF THE INVENTION

The invention disclosed herein relates to methods of conversion of thermal energy in high temperature gases called plasmas directly into electrical energy. Direct E×B, Magnetohydrodynamic, and Plasmadynamic conversion are plasma-to-electric conversion technologies in the class with direct electrostatic conversion of plasma energy and could be used for the conversion to electricity of fusion and laboratory plasma energy including those of both low and high power density. The power converter technologies disclosed here comprise magnetic fields, which permit positive ions to be collected separate from electrons using at least one electrode to produce voltage with respect to at least one counter electrode connected through a load.

Direct E×B conversion allows the extraction of electrical energy from a charge neutral plasma by requiring the hot, ionized gas to pass through a converter region consisting of crossed electric and magnetic fields, as well as electrode collector plates. Oppositely charged ions and electrons are separated though their respective particle drifts and/or finite Larmour orbit scale differences. E×B conversion possesses a distinct advantage in this way over electrostatic means of power extraction in that it acts on the entire neutral plasma simultaneously. The necessity to separate charge is thereby removed as are the space-charge complications that arise therefrom. Coupling to the plasma source and expansion (if necessary) are quite natural in an \overline{E}×\overline{B} converter with its applied guide field. As well, expansion may be unnecessary in this concept since energy extraction in crossed field concepts is perpendicular to both B and the direction of plasma extraction from the source. In the absence of expansion, dimensions can be greatly reduced. Collisions and end losses remain the principle concerns to high efficiency conversion. As is described herein, a reasonable quantity of electric power (several kW) may be extracted in such a converter design for plasma cell scale plasmas. To enhance power conversion and efficiency, both ion and electron collectors are provided showing quite promising ideal performance with conversion efficiency up to 70%.

The MHD converter exploits the Lorentz action on a flowing and electrically conducting magneto-fluid (plasma) across (or perpendicular to) a magnetic field to generate an electric potential difference at electrodes perpendicular to both the direction of plasma flow and the applied magnetic field. Power is extracted to an external load connected across the electrodes. MHD too operates on the entire body of the neutral fluid thereby eliminating the requirement for bulk charge separation. In addition, MHD is a fluid extraction technology thereby mitigating the deleterious influence of collisions, a strategy well suited to plasma cell conditions. Plasma-to-electric power extraction to 10s of kW with conversion efficiencies approaching 50% are realized for plasma cell conditions.

Plasmadynamic conversion (PDC) of thermal plasma energy to electricity is achieved by inserting two floating conductors directly into the body of a high temperature plasma. One of these conductors is magnetized by an external electromagnet or permanent magnet. The other is not magnetized. A complete analytic theory describing the potential difference between the two conductors (now appropriately referred to as electrodes) is described in the Description of the Invention section. This electrical potential difference is used to drive electrical current through an external load connected to the electrodes and thereby extract power in the form of electricity at the expense of plasma thermal power. Tens of volts have been extracted in this fashion, driving hundreds of mA in external loads. The PDC generation of electrical power was experimentally demonstrated at the ˜1-2 W level in laboratory plasma devices. These results were demonstrated to be in agreement with a complete analytic model describing electron current restriction to a magnetized electrode. Power-load curves identify the impedance matching condition at 250 Ω for the best conditions for which the peak PDC extracted power is ˜1.87 W and collection efficiency is ˜42%. Plasmadynamic conversion may be optimized for high power and efficiency, and is directly scalable to higher power in the kW to 100s of kW range. The system is simple with projected costs on the order of 1% those of fuel cells.

### BRIEF DESCRIPTION OF THE DRAWINGS

FIG. 1 illustrates the E×B converter schematic;

FIG. 2 illustrates ideal E×B converter efficiency as a function of the drift to thermal speed ratio; FIG. 3 illustrates the MHD converter schematic;

FIG. 4 illustrates the MHD converter voltage drop for sample converter as a function of applied magnetic field strength;

FIG. 5 illustrates the MHD converter current density as a function of applied magnetic field strength;

FIG. 6 illustrates the MHD converter power as a function of applied magnetic field strength;

FIG. 7 illustrates the MHD converter efficiency as a function of applied magnetic field strength including Hall losses Ξ=0.1, 0.3, 1.0;

FIG. 8 shows a schematic of the 1 in. glow type discharge tube and PDC electrode assembly;

FIG. 9 shows a schematic of the microwave discharge experiment apparatus;

FIG. 10 illustrates the open circuit (●) and 20 kΩ PDC (Δ) voltages in the glow discharge experiment as a function of magnet coil current (67.7 G/A) [Nominal operating conditions were 100 mA and 350 V discharge current and voltage. The dotted line shows the predicted open circuit voltage from Eq. 49];

FIG. 11 illustrates the PDC extracted voltage (.) and current (.) for load resistances from 100 Ω to 10 MΩ in the glow discharge experiment in 1 Torr He and I_{B}=5 A;

FIG. 12 illustrates the PDC extracted power as a function of load resistance in the glow discharge experiment in 1 Torr He and I_{B}=5 A;

FIG. 13 illustrates the PDC extracted power as a function of He gas fill pressure in the glow discharge experiment at R_{L}=20 kΩ and I_{B}=5 A;

FIG. 14 illustrates the PDC extracted power as a function of discharge current in the glow discharge experiment at 1 Torr He and I_{B}=5 A;

FIG. 15 shows Langmuir probe measurements of electron density in the microwave experiment as a function of microwave power density for 1 Torr He at 50 sccm;

FIG. 16 illustrates the PDC voltage (.) and current (.) as a function of load resistance in the microwave device at 8.55 W/cm³, and 1 Torr He at 50 sccm;

FIG. 17 illustrates the PDC extracted power as a function of load resistance in the microwave device at 8.55 W/cm³, and 1 Torr He at 50 sccm;

FIG. 18 illustrates the PDC potential as a function of microwave power density for R_{L}=600 Ω, and 0.75 Torr He at 50 sccm;

FIG. 19 illustrates the PDC extracted power as a function of microwave power density for R_{L}=600 Ω, and 0.75 Torr He at 50 sccm;

FIG. 20 illustrates the large electrode PDC extracted power as a function of He gas fill pressure at microwave power density of 8.55 W/cm³ and R_{L}=250;

FIG. 21 illustrates a design for an electromagnet which can be used to magnetize the plasma of a PDC device;

FIG. 22 illustrates a high power PDC collector and electrode assembly with electromagnets; and

FIG. 23 illustrates a schematic of a PDC scale up device with a set of 10 anode collectors.

### DESCRIPTION OF THE INVENTION

The following preferred embodiments of the invention disclose numerous property ranges, including but not limited to, voltage, current, pressure, temperature, and the like, which are merely intended as illustrative examples. Based on the detailed written description, one skilled in the art would easily be able to practice this invention within other property ranges to produce the desired result without undue experimentation.

A). Direct E×B and Magnetohydrodynamic Conversion

Plasma Parameters

Plasma cells operating in the glow discharge regime with 10 W input power and excess thermal balance of greater than 40 W are reported [R. L. Mills, et al., Int. J. Hydrogen Energy, 27(2002)651]. The output performance of such cells are optimized in mixtures of Ar and atomized H gas in a concentration of 3-5% (hereafter, referred to as the minority gas) in the presence of the alkali metals, Cs, K, Rb, or Sr. Plasma parameters have been determined by spectroscopic measurement and are summarized in table 1 along with fill gas parameters at 1 Torr.

TABLE 1
Typical plasma and fill gas parameters for
BLP Ar—H discharge cell

| | | |
|---|---|---|
| Electron Temperature | Tₑ | 10 eV |
| Ion Temperature | Tᵢ | 30-40 eV |
| Plasma Density | nₑ = nᵢ | 10¹²-10¹⁴ cm⁻³ |
| Majority Neutral Density | n_{Ar} | 3 × 10¹⁶ cm⁻³ |
| Minority Neutral | n_{H} | 1.5 × 10¹⁵ cm⁻³ |
| Density* | | |

*5% H minority concentration

Scale

Design base calculations will also fix magnetic field strength B˜1 T, and the physical scale of the converter to L˜1m. This selection is made for reasons of illustration and practicality. Fields on this order are readily produced with Weiss type electromagnets [F. Bitter, Rev. Sci. Instrum., 7 (1936) 479; Rev. Sci. Instrum., 7 (1936) 482] with iron or rare-earth cores and without active cooling. The choice of converter length is considered a reasonable upper limit at this point in the analysis for micro-distributed power devices without a detailed cost analysis. The parameters B and L at times will be treated as independent variables for the purpose of optimization or parameterization, though it is always recognized that practical considerations limit these to be of the order prescribed above.

Energy Content and Power Flow

To gauge the power scales involved, the following order estimates are performed. At Tₑ=10 eV, 40 eV, and n_{e,i}=10¹² cm⁻³, for a 1 liter cell, the stored thermal energy is

U_{T}=n_{e,i}V(kTₑ+kTᵢ)˜8 mJ [2]

and, of course, independent of ion species. Presuming the ability to extract this energy at an acoustic rate, power flow can be estimated. At 40 eV, H⁺ ions have an acoustic speed of ˜6×10⁴ M/s, while that for Ar⁺ ions is ˜10⁴ m/s. This makes the drift time for H⁺ ions t1.67 μs, and about 10 μs for Ar⁺ for a 10 cm drift path through the cell. Assuming particle replacement at the rate nvA (here nv is the particle outflux, and A is the flow channel cross section) to maintain steady conditions, thermal energy can then be extracted at a rate U_{T}/t˜4.8 kW for H⁺ and 0.8 kW for Ar⁺. This analysis is identical to setting the power output to the kinetic energy flow rate,

$$\frac{1}{2} {mv}^{2} ( nvA ) .$$

A similar argument can be made by considering the rate at which work is done on the fluid as it is expelled from the cell,

$$P = \frac{\partial W}{\partial t} ≅ Fv$$

for constant F. For F=pA, then P=pvA=nkTvA for an ideal gas.

All of the aforementioned arguments, of course, require that steady conditions are maintained while extracting energy at the estimated rate. To do this, plasma particles must be replaced at the rate nvA and heated to steady temperature T at the rate kT/t per particle.

Converter Concerns

It is considered convention in the direct conversion of plasma to electrical energy that a conversion system must perform the following tasks:

1. Extraction: A well defined plasma stream is extracted from the plasma confinement or reactor chamber.

2. Neutral Trapping: Neutral particles must be trapped or otherwise diverted from the plasma flow to ensure high quality plasma and reduce the deleterious effects of neutral interactions including elastic scattering and charge exchange recombination.

3. Expansion: The extant plasma stream must be expanded to (a) reduce the heat loading on converter surfaces such as electrodes, grids, . . . , and (b) convert plasma thermal energy to flow energy, thereby enhancing converter performance. (i.e. Extracting as much plasma energy in directed particle energy as possible is desirable in direct conversion since it is only directed kinetic energy that is converted to electrical energy.)

4. Separation: Charge separation is performed usually by electrostatic means. Ions and electrons are separated very early in the converter region. Before being individually collected, substantial space charge is developed which can severely limit performance especially at low energy (below a few keV).

5. Collection: Charged particles are decelerated at high voltage collectors (electrodes). For high efficiency, many electrodes may be required, each set at a different bias voltage to intercept ions with kinetic energy nearly equal to the bias potential.

6. Power Conditioning: To meet the needs of the end user, direct converter power (usually high voltage DC) must be conditioned to the requirements at the delivery site.

These are all challenging engineering issues for direct conversion. Neutral trapping incurs the need for diverting the plasma flow and a differential pumping system to remove the neutral inventory. Extraction may require a separate extraction chamber and additional magnet coils for guide fields. Expansion increases the physical dimensions and cost of the converter and supporting systems. Charge separation introduces the inevitable and sometimes fatal complication of space charge limitations.

Fortunately, however, many of these requirements are dictated by the high power and high energy per particle associated with the nuclear fusion origins of direct conversion. At lower power densities and particle energies, many of these constraints can be relaxed. For example, wall loading is not considered a materials concern at the few to tens of kW/m² typical of plasma cell power densities. Therefore, expansion may not be necessary unless there is a compelling conversion advantage (i.e. greatly increased conversion efficiency). Collecting plasma thermal or flow enegy directly (as in the E×B, MHD, and plasmadynamic conversion techniques) rather than first converting this energy to directed individual particle energy, eliminates the need for charge separation. This represents an enormous advantage and, in many cases, an enabling condition for low power converters. Space charge would otherwise pose an insurmountable obstacle. As an example, consider an infinitely wide (so that transverse space charge effects are neglected) beam of H⁺ ions at 10 eV and 1.6 kA/m². This beam has a longitudinal space charge limitation on the maximum collector length of ˜0.5 mm.

The complications associated with plasma extraction and neutral trapping may also be eliminated by considering conversion strategies that allow the immersion of electrodes in-situ or a collector region that is closely coupled to the plasma cell and provides a natural flow path from cell to collector as in the case of E×B, MHD, and plasmadynamic converters. Flow or collection interruption by neutral particles must still be considered, however.

Recombination

In low temperature plasmas, the recombination of free charge is often an important consideration in determining the concentration and distribution of charge states. This is especially true of low temperature plasmas that possess high neutral concentration and low ionization fraction. Three principle reactions dominate in the parameter range of interest, radiative recombination

e⁻+X⁺→X⁺hv [3]

dielectronic recombination

e⁻+e⁻X⁺→X+e⁻ [4]

to a somewhat lesser extent since it is a three body process, and charge exchange (CX)

X^{o}+Y⁺X⁺+Y [5]

where the underscore represents the energetic particle. Though the CX reaction does not alter the net concentration of ions in the plasma, it has the deleterious effect of removing energetic ions from the flow stream and replacing them with energetic neutral particles, leaving behind cold ions. CX may occur among particles of the same species (x=Y) or among different species so long as the ionization energetics permits.

Estimating the rate of dielectric and radiative recombination is important for any plasma to electric conversion scheme since these processes remove free charge from the inventory intended for collection. Conversion techniques such as MHD which depend on charge flow, are adversely affected by CX as well since this process also removes energetic ions from the flow. In this regard, conversion techniques that do not rely on flow, like plasmadynamic, may have an advantage.

The relevant recombination reactions then are those involving H⁺. Radiative recombination in H⁺ occurs with a rate coefficient of ˜10⁻¹³ cm³/s. Against an electron density of 10¹² cm³, this yields a recombination frequency of 0.1 s⁻¹ or a 10 s recombination time. The recombination mean free path at 40 eV is then in excess of 600 km, a completely ignorable process. CX, on the other hand, occurs at a much higher rate. The CX cross section for H⁺ on Ho is 10 cm. At 5% neutral H concentration, the CX mean path is on the order of 10 cm.

Direct E×B Converter

The kinematics expressions and conversion efficiency are developed for the direct \overline{E}×\overline{B} converter with both ion and electron collectors. The zeroth order behavior of an ideal \overline{E}×\overline{B} converter is described to retain analytically tractable formalism. In the absence of significant expansion, collisions may reduce the efficiency of such devices by interrupting ion trajectories to the collector.

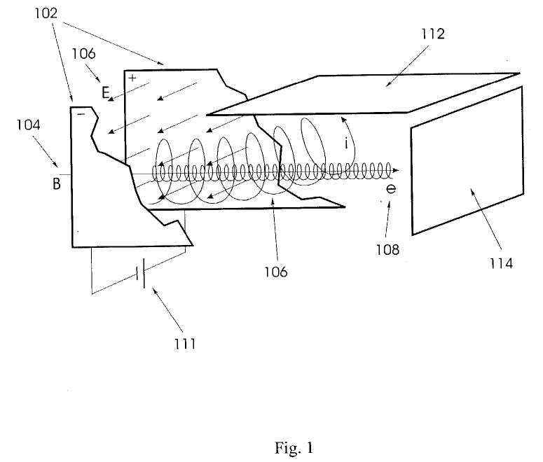

A schematic of a converter based on \overline{E}×\overline{B} collection is shown in FIG. 1. Here a rectangular arrangement of electrodes (102) is chosen for simplicity with plasma particles incident from the left and drifting along guide field, \overline{B} (104). When both ions (106) and electrons (108) enter the collector region and experience the applied crossed fields E (110) [provided by power source (111)] and B, they will immediately assume a guiding center drift in the direction and with speed \overline{V}_{E}=\overline{E}×\overline{B} perpendicular to both \overline{E} and \overline{B}. Thought this speed is identical for ions and electrons, ions having greatly reduced translational speed parallel to B (for T. =Te), will be turned and deflected to the upper electrode (112) before electrons. For the same transit time, high-speed electrons will then intercept the end electrode (114). The addition of electron collection increases direct power conversion.

Direct electromagnetic conversion like \overline{E}×\overline{B} offers distinct advantage over electrostatic conversion for a number of reasons. Perhaps the single most important is that \overline{E}×\overline{B} conversion (like all fluid drift conversion processes) acts on the entire neutral plasma simultaneously. The necessity to separate charge is thereby removed as are the space-charge complications that arise therefrom. Coupling to the plasma source and expansion (if necessary) are quite natural in an \overline{E}×\overline{B} converter with its applied guide field. As well, expansion may be unnecessary in this concept since energy extraction in crossed field concepts is perpendicular to both \overline{B} and the direction of plasma extraction from the source. In the absence of expansion, dimensions can be greatly reduced. Collisions and end losses remain the principle obstacles to high efficiency conversion.

To assess the benefit of expansion in an \overline{E}×\overline{B} converter, an analysis is performed on expansion kinematics and collection efficiency. All plasma and field parameters before the flow enters the expander are identified with the subscript 1, and those upon exiting the expander and entering the converter are identified with subscript 2. For plasma particles initially at total energy W₁=W_{⊥1}+W_{∥1}, equipartition requires that W_{⊥1}=W_{∥1} where ⊥ and ∥ refer to directions perpendicular and parallel to the guide field, respectively, so that

$$\begin{matrix}\begin{matrix}{v}_{{‖}_{1}} = \sqrt{\frac{{kT}_{1}}{M}} \\ and\end{matrix} & [ 7 ] \\ {v}_{{⊥}_{1}} = \sqrt{\frac{2 {kT}_{1}}{M}} & [ 8 ]\end{matrix}$$

where M is the species mass. An expander region must conserve magnetic flux so that for cross sections of linear dimension d₁ and d₂ at the inlet and outlet of the expander respectively, we have

B₁d²₁=B₂d²₂ [9]

Assigning d₁=ad₂, where a is a dimensionless, inverse expansion ratio, flux conservation can be expressed as B₂=a²B₁. By conserving the adiabatic invariant μ=W_{⊥}/B, expressions for the post expansion particle speed are obtained

$$\begin{matrix}\begin{matrix}{v}_{{⊥}_{2}} = a \sqrt{\frac{2 {kT}_{1}}{M}} \\ and\end{matrix} & [ 10 ] \\ {v}_{{‖}_{2}} = {( \frac{3}{2} - {a}^{2} )}^{1 / 2} \sqrt{\frac{2 {kT}_{1}}{M}} & [ 11 ]\end{matrix}$$

Note that when a=1, the no expansion limit, then v_{⊥}_{₂}=v_{⊥}_{₁} and v_{∥}_{₂}=v_{∥}_{_{1.}}

Conserving mass flow nvA=const (where A is the channel cross section at any position) determines the particle density change across the expander section

$$\frac{{n}_{2}}{{n}_{1}} = \frac{{a}^{2}}{{( 3 - 2 {a}^{2} )}^{1 / 2}} \qquad [ 12 ]$$

Coupling this result to an adiabatic expansion requirement (pV^{γ}=const) and the ideal gas law (p=nkT), indicates a temperature difference across the expander region

$$\frac{{T}_{2}}{{T}_{1}} = {( 3 - 2 {a}^{2} )}^{1 / 2} {( h / l )}^{γ} {a}^{2 γ - 2} \qquad [ 13 ]$$

where h and l are the lengths of the cell and expander regions, respectively. At h/l=½, a=½, and γ=5/3, the relative temperature decrease is found to be T₂/T₁˜0.2.

Ion energy extraction requires ion drift at \overline{E}×\overline{B} to the ion collector. The rate if ion collection is then

Rᵢ=n₂v_{E/B}lΔ [14]

where Δ˜2d₂ is the width of the collector electrodes. Since ions bring only perpendicular energy We to collection, the rate of energy collection is

$${P}_{i} = {n}_{2} {v}_{E / B} l Δ {W}_{{⊥}_{2}} = \frac{{a}^{4}}{{( 3 - 2 {a}^{2} )}^{1 / 2}} {n}_{1} {kT}_{1} \frac{E}{{B}_{2}} l Δ \qquad [ 15 ]$$

Electrons by contrast bring W₁₁ to the electron collector since they drift parallel to B. Ambipolar considerations require electrons to reach their collector at the same rate that ions reach the ion collector, so that

n₂v_{E/B}lΔ=n₂v_{∥}2eΔ² [16]

and the electron drift speed is limited to v₁₁₂=(l/Δ)v_{E/B}. The collected electron power is then

$${P}_{e} = {n}_{2} {v}_{{‖}_{2 e}} {Δ}^{2} ( \frac{1}{2} {mv}_{{‖}_{2 e}}^{2} ) = \frac{{n}_{1} {a}^{2}}{{( 3 - 2 {a}^{2} )}^{1 / 2}} \frac{m}{2} \frac{{l}^{3}}{Δ} {( \frac{E}{{B}_{2}} )}^{3} \qquad [ 17 ]$$

Combining ion and electron power, the total collected power is

$$P = \frac{{n}_{1} {a}^{3}}{{( 3 - 2 {a}^{2} )}^{1 / 2}} {ld}_{1} \frac{E}{{B}_{2}} [ 2 {kT}_{1} + \frac{m}{4} \frac{{l}^{2}}{{d}_{1}^{2}} {( \frac{E}{{B}_{2}} )}^{2} ] \qquad [ 18 ]$$

For l/dᵢ>>1, P peaks at a ˜\sqrt{3/2}. Since the maximum for the inverse expansion ration is 1, expansion is not desirable here. At a=1, there is no adiabatic change in fluid parameters across the expander region, and

$$P = nld \frac{E}{B} ( 2 kT ) [ 1 + \frac{m}{8} \frac{{l}^{2}}{{d}^{2}} {( \frac{E}{B} )}^{2} \frac{1}{kT} ] \qquad [ 19 ]$$

separating the ion and electron contributions, respectively, within the square brackets.

The power input to the converter has two contributions. Thermal flow power from the cell is estimated

$${P}_{flow} = 3 nkT \sqrt{\frac{kT}{M}} \frac{π {Δ}^{2}}{4} \qquad [ 20 ]$$

and in addition, there is a contribution from the work required of an external agent (power supply) to maintain the electric field in the converter in the presence of particle drifts

$${P}_{E} = {nv}_{E / B} Δ l ( \frac{1}{2} {Mv}_{E / B}^{2} ) \qquad [ 21 ]$$

By the mass difference M>>m, the ion contribution is the only important one. The converter efficiency is defined a η=P/Pᵢₙ where Pᵢₙ=P_{flow}+P_{E}. Defining a new parameter as the dimensionless, drift to thermal speed ratio, α=v_{E/B}/vₜₕ=(E/B)\sqrt{kT/M}, the efficiency expression is parameterized

$$η = \frac{1 + \frac{m}{8 M} {( \frac{l}{d} )}^{2} {α}^{2}}{\frac{3 π}{2} \frac{d}{l α} + \frac{{α}^{2}}{2}} \qquad [ 22 ]$$

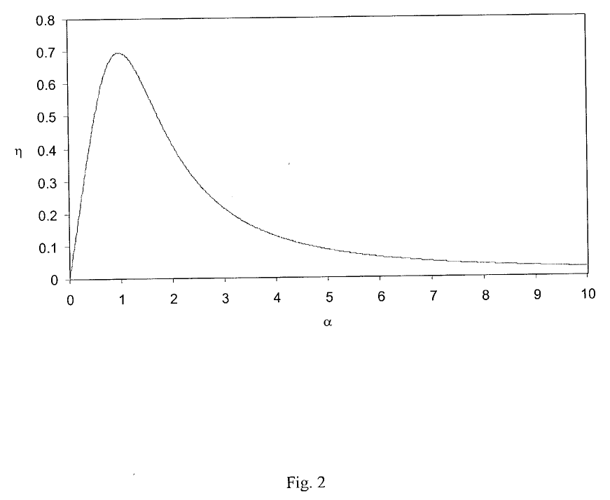

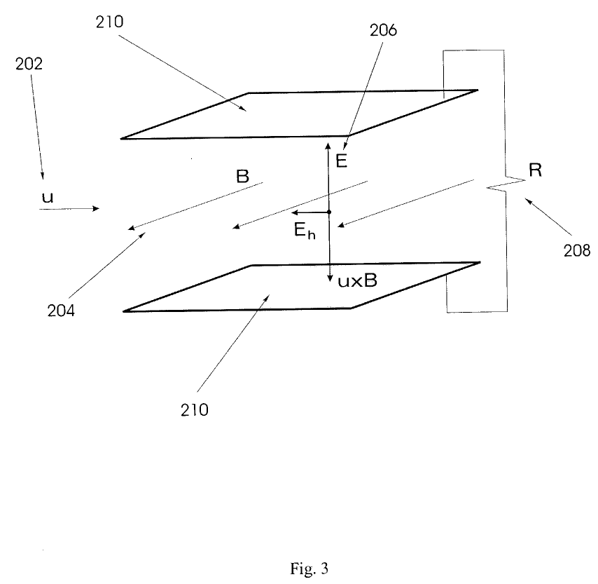

With l/d˜5, the conversion efficiency peaks at η˜70% near α˜1. This is demonstrated in FIG. 2 as a parameterization of η vs. α with l/d=5.

Some additional conditions should be considered. Firstly, to avoid transverse ion loss it is necessary to ensure r_{L}_{ᵢ}<Δ/2, the ion gyro-scale fits within the channel dimensions. This requires B>\sqrt{2kT}/qd˜45 G for 10 eV H-ions at d=10 cm, a trivial requirement. More limiting is ensuring a drift time much larger than the ion gyro-time to allow fully developed ion drift flow to intercept the upper electrode (ΔB/E)>ω⁻¹_{c}_{ᵢ}. This places an upper limit on E<ΔqB²/M of E<7600 V/m when B=200 G. Since l/d>1 is required for v_{∥}2c >V_{E/B}, this forces l˜½-1m. The condition for equal ion and electron contributions to output power is

$$E = \frac{2 \sqrt{2}}{5} B \sqrt{\frac{kT}{m}} ∼ 15 , 000 V \text{/} m \qquad [ 23 ]$$

again for 10 eV and 200 G. This is superceeded by the gyro-time requirement. It is more reasonable then to fix the electric field to a lower value near a 1. For example, at E=1000 V/m (or V=200 V for Δ˜20 cm) and B=200 G at 10 eV, one finds α˜1.6 and η˜54% (from Eq. [22]). The order of power output under these conditions (and with n˜10¹² cm⁻³), is P˜4.7 kW. Therefore, a reasonable quantity of electric power may be extracted in such a converter design provided that collisional effects are not important.

MHD Converter

The MHD converter exploits the Lorentz action on a flowing and electrically conducting (magneto-) fluid across a magnetic field to generate an electric potential difference. A schematic illustrating the MHD fundamentals is shown in FIG. 3. Magneto-fluid flow is incident from the left at flow velocity \overline{u} (202). As the flow enters the converter region, it experiences crossed field \overline{B} (204). In the absence of an external load shunting the electrodes, an open-circuit electric field \overline{E}ₒ=−\overline{u}×\overline{B} is generated. This is a direct expression of the plasma Ohm's Law when the flow of electric current is prevented. When finite currents are allowed to conduct, the relationship between electric current density \overline{j} and \overline{E} (206) (i.e., Ohm's law) may be written

\overline{j}=σ(\overline{E}+\overline{u}×\overline{B}) [24]

where σ is the electrical conductivity of the magneto-fluid. The circuit is completed through the external load (208) which reduces the electrode voltage so that \overline{E}=κ\overline{E}ₒ=−κ\overline{u}×\overline{B} where κ<1, so that the magnitude of the current density becomes j=σ(1−κ)uB.

The continuous appearance of an MHD voltage, V=Ed, (where d is the electrode gap) and electric current flow is predicated upon continuous fluid flow through the channel defined by the converter electrodes (210). The flow may be maintained via a pressure drop, Δp, across the channel so that the plasma component of the fluid is in dynamic equilibrium with the applied field

Δp=\overline{j}×\overline{B} [25]

or Δp=jbL for a linear pressure drop (i.e. constant B,j) across a channel of length L. The converter length required to support the fluid at fixed B can then be written

$$L = \frac{Δ p}{σ ( 1 - κ ) {uB}^{2}} \qquad [ 26 ]$$

indicating a reduction in scale for concomitant increases in u, B², or σ. When the field magnitude and flow speed are fixed by power and materials limitations, there is a premium on a high degree of conductivity for the fluid. The electrical conductivity in plasma is determined by a number of factors including species, charge, average thermal speed, collision cross section [S.C. Brown, Basic Data of Plasma Physics, MIT Press, Cambridge, 1959], and B. A detailed analysis on conduction in partially ionized gases will follow.

In order to maintain pressure drop, and hence flow, evacuation is required of the fluid extant from the converter. Three scenarios present themselves to attain this goal. (1) The plasma cell and converter may be directly coupled and open to vent (atmosphere) in a once-through “open” system. The pressure drop is maintained by a vacuum pump or by operating at greater than atmospheric pressure. (2) The cell and converter may be arranged in a “closed” configuration which utilizes a recirculating pump to accumulate the converter effluent and divert it back to the injection reservoir in the cell. The cells described here do not operate at such high pressure. As well, neither of the pump schemes in (1) or (2) are beneficial in an energy conversion system since the pumping power required to maintain Δp and hence u is greater than that converted to electrical power by the flow. (3) Hot plasma generated in the plasma cell and expanding outward therefrom into the converter region, may introduce an adverse pressure gradient which may be filled by backflow of neutral gas from the converter region back to the cell. A “natural convection” like pattern may be established providing both continuous flow and refueling simultaneously. The plasma cell and converter may then be coupled in a simply closed configuration without need for pumping.

Power flow through the external load at MHD supported \overline{j} and \overline{E} is

P=\overline{j}·\overline{E}=σκ(1−κ)u²B² [27]

This is optimized at κ=½, which represents the matching condition where half the open-circuit voltage drop appears across the load. Under this condition, the source and load impedances are matched.

Electrical Conductivity in B

As the electrical performance of the MHD converter is a strong function of the electrical conductivity, σ, the accuracy of quantitative determination is of paramount importance. Indeed, when the high concentration of neutral particles is in flow and thermal equilibrium with plasma ions and electrons, it is noted [C. Mannal and N. W. Mather, Eds., Engineering Aspects of Magnetohydrodynamics, Columbia University Press, NY, 1962] that the MHD efficiency of conversion is limited to the ionization fraction. This is a rather debilitating limitation as the ion fraction may be quite low, perhaps only a few percent or less. At low pressure, however, no such equilibrium exists. The greatly reduced collisionality afforded by low density somewhat decouples the plasma from neutral particles. Input power then is not required to heat the large inventory of neutrals, nor is it required to drive flow in this component so that the input power requirements may be much reduced and the electrical efficiency much greater.

The strong applied magnetic field, on the other hand, does have a dramatic influence [H. J. Pain and P. R. Smy, J. Fluid Mech., 9 (1960) 390; M. Sakuntala, et al., Phys. Rev., 118 (1960) 1459] on conduction. This can be immediately ascertained from the electron momentum equation

$${n}_{e} {m}_{e} [ \frac{\partial {\vec{v}}_{e}}{\partial t} + ( {\vec{v}}_{e} \cdot ∇ ) {\vec{v}}_{e} ] = - {en}_{e} ( \vec{E} + {\vec{v}}_{e} \times \vec{B} ) - ∇ {p}_{e} - {v}_{e} {n}_{e} {m}_{e} {\vec{v}}_{e} \qquad [ 28 ]$$

where Δpₑ is the electron pressure gradient and vₑ is the electron collision frequency such that the last term determines the rate of momentum change in the electron fluid due to collisions with particles of other species. This equation may be readily solved under some limiting, yet illustrative, conditions of constant and uniform conditions with \overline{B}=B\overline{z} and ΔTₑ=0 to yield the familiar expression for the transverse electron speed

$${\vec{v}}_{e} = \frac{{Ω}_{e}^{2}}{1 + {Ω}_{e}^{2}} ( {E}_{y} / B ) + \frac{{Ω}_{e}^{2}}{1 + {Ω}_{e}^{2}} \frac{{kT}_{e}}{eB} \frac{{V}_{y} {n}_{e}}{{n}_{e}} - \frac{{μ}_{e}}{1 + {Ω}_{e}^{2}} {E}_{x} - \frac{{D}_{e}}{1 + {Ω}_{e}^{2}} \frac{{V}_{x} {n}_{e}}{{n}_{e}} \qquad [ 29 ]$$

where μₑ=e/(mₑvₑ) is the electron mobility, Dₑ=kTₑ/(mₑvₑ) is the electron mass diffusivity, and Ωₑ=ω_{c}_{ₑ}/vₑ=eB/mₑvₑ=μₑB is the electron magnetization parameter. For Ωₑ>>1, the electron fluid is magnetized and strongly influenced by B. Where Ωₑ<<1, the applied field has much less influence than collisions on electron transport. The first two terms in Eq.[29] are the familiar electric (\overline{E}×\overline{B}) and diamagnetic (Δp) drift terms perpendicular to B. The last two terms represent electrostatic mobility and diffusive transport, yet the magnitude of the transport coefficients is reduced by the factor (1+Ω²ₑ)

$$\begin{matrix}{μ}_{{e}_{⊥}} = \frac{{μ}_{e}}{1 + {Ω}_{e}^{2}} , & {D}_{{e}_{⊥}} = \frac{{D}_{e}}{1 + {Ω}_{e}^{2}}\end{matrix} \qquad [ 30 ]$$

which may be a significant reduction for large B. Alternatively, the effective collisionality is increased

V_{e⊥}=vₑ(1+Ω²), η_{e™}=ηₑ(1+Ωₑ²) [31]

Because of the mass difference, ions and electrons are influenced by collisions and B to differing degrees. Table 2 shows ion and electron collision frequencies with all species present (e, H⁺ ions, Ar^{o} neutrals) for the BLP plasma cell conditions of table 1 with 40 eV ions, 10¹² cm⁻³ plasma density, and a Coulomb logarithm of 20. Charge neutral collisions are among ions or electrons with neutral Ar atoms at 1 Torr base pressure. Coulomb collisions are self (i-i or e-e) or cross (i-e or e-i) involving electrons and H⁺ ions as the only ionized species. Conduction for both ions and electrons is limited by collisions with neutral particles due principally to the large inventory of neutrals at 1 Torr. These mechanisms (i.e. vₑₙ, vᵢₙ) will then be considered the only important collisional effects.

TABLE 2
Ion and electron collision frequencies in BLP plasmas for the
conditions of table 1 with 40 eV hydrogen ions, 10¹² cm⁻³
plasma density, and Coulomb logarithm of 20.

| | Neutrals: νₓₙ (s⁻¹) | Electrons: νₓₑ (s⁻¹) | Ions: νₓᵢ (s⁻¹) |
|---|---|---|---|
| Electrons | 6 × 10⁹ | 2.7 × 10⁶ | 2.7 × 10⁶ |
| Ions | 3.6 × 10⁸ | 2 × 10³ | 7.8 × 10³ |

In weak magnetic fields (Ω_{i,e}<<1), both ions and electrons are relatively unaffected by the presence of B. Electrons, then, due to their higher mobility, dominate electrical conduction. When the magnetic field strength increases such that Ω_{i,e}>>1 (the strong field limit), both ions and electrons are magnetized and electrical conduction, perpendicular to B is dominated by ion flow. For intermediate fields, as for our design case near B˜T, both ions and electrons conduct electrical current. To see this, a conductivity ratio can be estimated

$$\frac{{σ}_{{e}_{⊥}}}{{σ}_{{i}_{⊥}}} = \frac{{σ}_{e}}{{σ}_{i}} ( \frac{1 + {Ω}_{i}^{2}}{1 + {Ω}_{e}^{2}} ) \qquad [ 32 ]$$

At 1 T, Ωₑ˜29.3 and Ωᵢ˜0.27 (H⁺ ions) while σₑ/σᵢ=μₑ/μᵢ˜85.7. The conduction ratio perpendicular to B then becomes σₑ_{_{⊥}}/σ_{o⊥}˜0.1 so that electrons carry only about 10% of the electrical current in the converter.

Performance

MHD converter performance can be illustrated by examining a test case, allowing B˜1 T, κ=½, Δp=1 Torr, and u=1.36×10⁴ M/s (ion acoustic speed at neutral inertia). For vₑ_{_{⊥}}=0.1vᵢ_{_{⊥}}, and nₑ˜10¹² cm⁻³, the plasma conductivity perpendicular to B is estimated at σ_{⊥}=1.1σᵢ_{_{⊥}}=1.1enᵢμᵢ=0.048 mho/m or η_{⊥}=21 Ωm. Then employing expression [26], a converter length of only L˜40 cm is found. This is a modest requirement and suggests that such large fields may not be necessary. The MHD electric field generated in this case is E=κuB˜6.8 kV/m, providing a voltage drop of 680 V across the 10 cm converter gap. The electric current density can then be estimated from Eq.[24] to be j˜326 A/m² so that the MHD output power becomes P=IV=j(Ld)V˜8.8 kW.

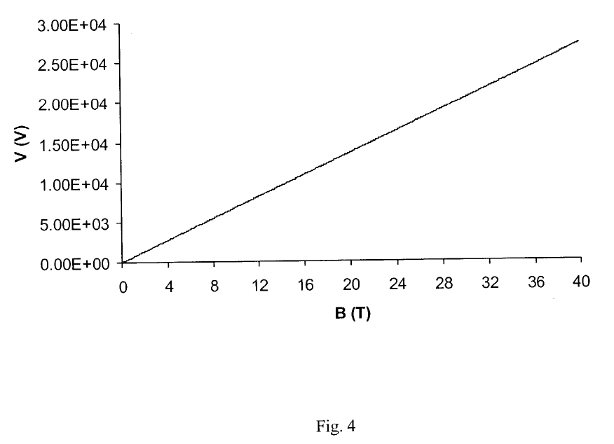

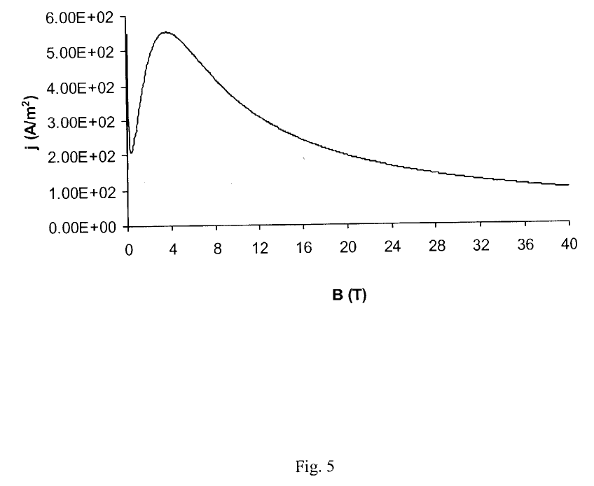

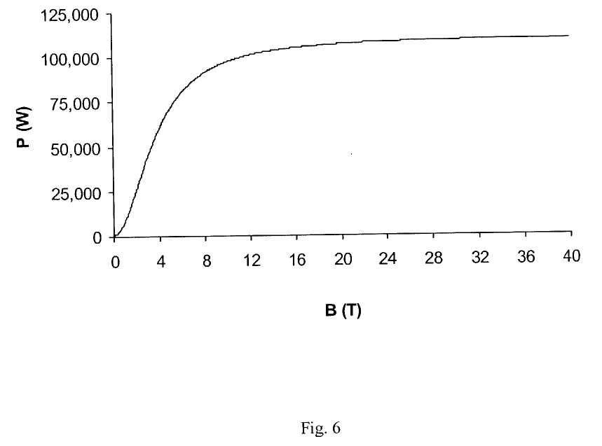

FIGS. 4-6 show MHD voltage drop, current density, and power as functions of applied field, B, from 0-40 T at constant L and u. Though the upper limit on B is clearly impractical, the range encompasses all the relevant MHD physics. The MHD voltage (FIG. 4) increases linearly with B since flow speed and coupling constant (κ) are fixed. The electric current density (FIG. 5), however, shows much more interesting behavior. There are two peaks in the curve, one at each B˜1/μₑ, before asymptotically decreasing to zero as B→∞. This behavior is explained by considering the perpendicular conductivity or mobility of charges in strong B. At low field (B<1/μₑ), electrons easily conduct in the influence of E and j increases linearly with B since E increases with B. As B approaches 1/μₑ=0.034T, electrons become magnetized and are greatly impeded in their flow perpendicular to B, so that j decreases rapidly. This situation is sometimes referred to as the “ion slip” condition [R. J. Rosa, Phys. Fluids, 4 (1961) 182] since ions continue to slip through the applied field whereas electrons are trapped. In the region of B parameter space between 1/μₑ and 1/μᵢ, there is a competition between conductivity reduction and increasing EMF with B. At B˜1/μᵢ˜3.7 T, ions now become magnetized and the current once again peaks. Beyond this field strength, the current is a continuously decreasing function of B. The MHD power (FIG. 6) is a continuously increasing function of B in spite of the variation in j with B since E is continuously increasing. The power function reaches an asymptotic value (P_{∞=κ(I-κ)d}²Lu²en/μᵢ˜110 kW for this case) at high field since the E increase is linear with B and j decreases like B⁻¹ at large B.

Though the output power can approach appreciable levels, the quantity of total electric current remains low, I≦25 A (and j≧600 A/m²) so that induced fields remain negligible in comparison with the applied field. The magnetic Reynolds number Rₘ=μₒσ_{⊥ud˜}10⁻⁵ determines the scale of flow interactions with the applied field. Since Rₘ<<1, the complications usually associated with flow-field distortion, hydromagnetic waves, and instabilities can be avoided.

Channel Hydrodynamics

The hydrodynamics of 1-D channel flow (\overline{u}=u\hat{x}) in crossed field (\overline{B}=B\hat{z}) is examined by considering the conservation equations of hydrodynamics

$$\begin{matrix}energy : & ρ u \frac{ⅆ}{ⅆ x} ( \frac{{u}^{2}}{2} + {C}_{p} T ) = \vec{j} \cdot \vec{E} \\ momentum : & ρ \vec{u} \frac{ⅆ u}{ⅆ x} + ∇ p = \vec{j} \times \vec{B} \\ continuity : & \dot{m} = ρ uA = const\end{matrix} \qquad [ 33 ]$$

for fluid of mass density ρ in channel of cross section A. If constant flow (u=const.) is considered, the hydrodynamics equations are simplified to

$$\begin{matrix}energy : & ρ u \frac{ⅆ}{ⅆ x} ( {C}_{p} T ) = \vec{j} \cdot \vec{E} or \frac{ⅆ h}{ⅆ x} = \frac{\vec{j} \cdot \vec{E}}{ρ u} \\ momentum : & ∇ p = \vec{j} \times \vec{B} \\ continuity : & ρ A = const\end{matrix} \qquad [ 34 ]$$

where h is the specific enthalpy.

In constant applied field and disregarding flow distortion of the applied field as indicated by the tiny order of the magnetic Reynolds number, the pressure profile must be linear. By integrating the momentum Eq.

p(x)=2j_{y}BL[1−x/2L] [35]

on 0≦x≦L. Given the pressure profile above and ideal gas behavior, p=nkT, the energy equation can be integrated to find the temperature profile

$$T ( x ) / {T}_{o} = {[ 1 - x / 2 L ]}^{- \frac{kE}{{umBC}_{p}}} \qquad [ 36 ]$$

Since E=κuB, the exponent reduces to κk/mCₚ0.33 using the properties of Ar as the bulk species. At the channel exit, T(L)/Tₒ=1.26 where the temperature increase is attributed to Joule heating of the plasma by the MHD current and field. Since the temperature and pressure profiles are determined, the density profile can be found

$$\begin{matrix}n ( x ) = {\frac{2 {j}_{y} BL}{{kT}_{o}} [ 1 - x / 2 L ]}^{1 + \frac{kE}{{umBC}_{p}}} \\ = {{n}_{o} [ 1 - x / 2 L ]}^{1.33}\end{matrix} \qquad [ 37 ]$$

The extant flow (at x=L) then has density reduction n(L)/nₒ˜0.4.

By mass conservation, the channel cross section must widen to support constant flow while the density decreases, A˜1/p. Then it is readily determined

$$\begin{matrix}A ( x ) = {\frac{\dot{m} {kT}_{o}}{2 {j}_{y} BL} [ 1 - x / 2 L ]}^{- ( 1 + \frac{kE}{{umBC}_{p}} )} \\ = {{A}_{o} [ 1 - x / 2 L ]}^{- 1.33}\end{matrix} \qquad [ 38 ]$$

As the flow exits the channel, Eq.[38] predicts that the gap must widen to A(L)/Aₒ˜2.5 or d(L)/dₒ˜1.6 to accommodate constant flow.

Generator Efficiency and the Hall Effect

The preceding analysis considers only the idealized behavior of an MHD converter, that is the electro- and hydro-dynamic behavior in the absence of heat and particle losses and Hall currents. Collisions, on the other hand, are fully accounted for through the explicit determination of collision frequency and its implementation in the Ohm's Law. (Eq.[24]).

In this context, the MHD efficiency may be quantified by considering the following. The output power density is determined by the rate at which specific enthalpy in the flow is converted to electrical energy

$$ρ u \frac{ⅆ h}{ⅆ x} = \vec{j} \cdot \vec{E} = {j}_{y} E \qquad [ 39 ]$$

The rate at which energy is expended is attributed to work done by the fluid in expanding through the applied magnetic field

$$u \frac{ⅆ p}{ⅆ x} = {uj}_{y} B \qquad [ 40 ]$$

The ratio of these two expressions is the MHD efficiency

$${η}_{MHD} = \frac{E}{uB} = κ \qquad [ 41 ]$$

This quantity is a constant (κ=½) in the heretofore provided formalism since no physical effects other than impedance matching are considered.

At high applied field strength, however, the Hall effect may plan an important role in channel dynamics [D. C. Black, et al., Phys. Plasmas, 4 (1997) 2820; D. C. Black, et al., Phys. Plasmas, 1 (1994) 3115; K. F. Schoenberg, et al., IEEE Trans. Plas. Sci., 21 (1993) 625]. The Hall effect in plasma is a consequence of electric current interaction with applied magnetic fields just as that experienced in metalic conductors. In plasma, though, this effect can have significant impact on plasma impedance and dynamics. The Hall effect is quantified via the generalized Ohm's Law

$$\vec{E} + \vec{u} \times \vec{B} = \frac{1}{σ} \vec{j} + \frac{1}{en} ( \vec{j} \times \vec{B} - ∇ {p}_{e} ) \qquad [ 42 ]$$

where the last two terms were omitted in the form previously used (Eq.[24]). The \overline{j}×\overline{B} term on the right side is the Hall term. The last term represents the electrodynamic influence of electron pressure gradients and is ignorable when βₑ=2 μₒkTₑ/B²<<1. For BLP conditions βₑ˜10⁻⁶ at 1 T so that neglecting electron pressure is well justified.

The Hall contribution, however, is most often not ignorable. It can have quite a strong influence on plasma and electrodynamics, and energy balance in MHD plasmas [D. C. Black, et al., Phys. Plasmas, 4 (1997) 2820; D. C. Black, et al., Phys. Plasmas, 1 (1994) 3115; K. F. Schoenberg, et al., IEEE Trans. Plas. Sci., 21 (1993) 625]. Via the Hall term, there is introduced a component of electric current and field perpendicular to B. For the cartesean MHD channel described earlier with \overline{B}=(0,0,B), \overline{u}=(u,0,0), resulting in MHD fields E_{y} and j_{y}, the Hall contribution appears in the −\hat{x}-direction as shown in FIG. 3

$${E}_{hall} = {E}_{x} = \frac{1}{σ} {j}_{x} + \frac{1}{en} {j}_{y} B \qquad [ 43 ]$$

where jₓ is the Hall current. Lacking experimental guidance or further theoretical constraints on jₓ, parameterization with respect to the Morozov [D. C. Black, et al., Phys. Plasmas, 1 (1994) 3115; K. F. Schoenberg, et al., IEEE Trans. Plas. Sci., 21 (1993) 625] Hall parameter is introduced

Ξ=jₓ/enu [44]

The MHD efficiency expression is then suitably modified to incorporate the rate at which energy is expended in driving Hall currents

$${η}_{MHD} = κ \frac{1}{1 + \frac{{j}_{x} {E}_{x}}{{uj}_{y} B}} \qquad [ 45 ]$$

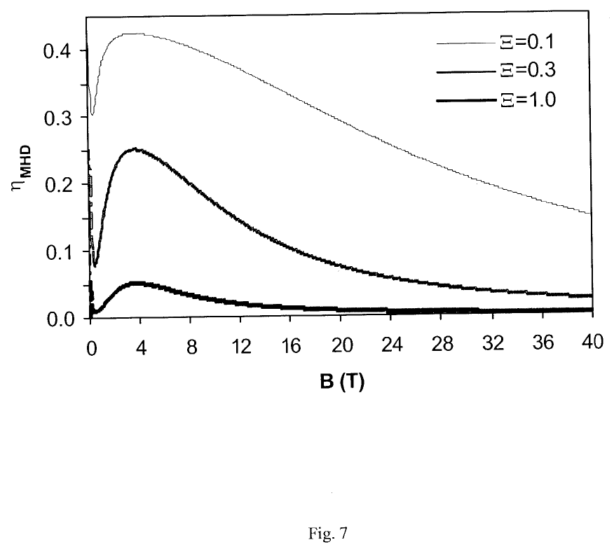

No credit is taken here for the potential for power conversion if the Hall current component. This has been suggested elsewhere [R. J. Rosa, Phys. Fluids, 4 (1961) 182; C. Mannal and N. W. Mather, Eds., Engineering Aspects of Magnetohydrodynamics, Columbia University Press, NY, 1962] and should be considered to further improve the overall performance of the converter. FIG. 7 displays the MHD efficiency including Hall losses as a function of the applied field for Ξ=0.1, 0.3, 1.0. Smaller Hall parameter is clearly desirable here. As Ξ is increased, a greater fraction of converter power is diverted to drive Hall currents. The effect is increased with increasing B since Eₕₐₗₗ˜B for large B.

Flow

In the absence of spontaneous plasma flow from the hot CA-plasma cell to the relatively cold MHD converter section, a directional plasma flow may also be formed by using a magnetic mirror. A magnetic mirror has a magnetic field gradient in the desired direction of ion flow where the initial parallel velocity of plasma particles increases as the orbital velocity decreases with conservation of kinetic energy and adiabatic invariant μ=W_{⊥}/B, the linear energy being drawn from that of orbital motion. The adiabatic invariance of flux through the orbit of an ion is a means to form a flow of ions along the field with the conversion of W_{⊥}to W_{∥}.

Plasma is selectively generated in the center region of the CA-plasma power cell. A magnetic mirror located in the center region causes electrons and ions to be forced from a homogeneous distribution of velocities at the cell center to a preferential velocity along the axis of the magnetic mirror. Thus, the plasma ions have a preferential velocity along the field and propagate into the MHD power converter. By preserving the adiabatic invariant, the parallel velocity at any position along the z-axis is given by

$${v}_{{∥}_{o}}^{2} = {v}_{o}^{2} - {v}_{{⊥}_{o}}^{2} \frac{B}{{B}_{o}}$$

where the zero subscript represents the initial condition at the cell center. In the case that v_{∥o}²=0.5vₒ² and B/Bₒ=˜0.1 at the MHD power converter, the particle velocity is 95% parallel to the field at the converter.

B). Plasmadynamic Conversion

High temperature plasmas possess a substantial inventory of energy stored in the thermal and/or kinetic components of plasma ions, electrons, and in some cases neutral gas particles in some weakly ionized plasmas. There is obvious incentive in devising methods and technologies to efficiently extract this energy and convert it to a more useful form. Most often, conversion to electrical energy is desired as this form is readily stored and transmitted, and is efficiently converted to mechanical work at the delivery site.

A number of plasma energy conversion schemes have been studied in the four plus decades of controlled thermonuclear fusion research. At high temperature (as that produced in the blanket material of high power D-T fusion reactor) a thermal steam cycle [R. G. Mills, Nuclear Fusion, 7(1967)223, D. L. Rose, Nuclear Fusion, 9(1969)183] is usually considered the most practical energy extraction means as the bulk (80%) of the energy release is in the form of chargless neutrons. Thermal steam cycles are robust, reliable, proven technologies, and are well established as the work horse of modern electrical power delivery. Yet, the conversion efficiency is limited and high coolant temperatures are required. Furthermore, costs are prohibitive for the use of steam cycles in small, distributed power sources.

Direct conversion of plasma charged particle kinetic to electric energy [G. H. Miley, Fusion Energy Conversion, American Nuclear Society, La Grange, Ill., 1976] may represent an attractive alternative to the steam cycle for at least several plasma systems of great interest including; (a) the D-T fusion reactor (as a “topping” unit to extract the 20% of fusion energy in high energy charged particles), (b) advanced, a-neutronic fueled fusion reactors, and (c) chemically assisted (CA)-plasma cells [R. Mills, N. Greenig, S. Hicks, Int. J. Hydrogen Energy, 27(2002)651, R. Mills, M. Nansteel, and Y. Lu, Int. J. Hydrogen Energy, 26 (2001) 309, R. L. Mills and P. Ray, New J. Phys., 4 (2002) 22.1]. In fusion reactors, the fully ionized, high temperature (up to 10-15 keV) plasma energy may be readily extracted by direct, electrostatic means, thereby converting charged particle kinetic energy to electrostatic potential energy via decelerating electrodes [G. H. Miley, Fusion Energy Conversion, American Nuclear Society, La Grange, Ill., 1976]. Whereas for CA-plasma cell devices, possessing only weakly ionized and relatively cold plasmas, conversion methods more compatible with a fluid environment like MHD converters [R. M. Mayo, R. L. Mills, and M. Nansteel, On the Potential for Direct or MHD Conversion of Power from a Novel Plasma Source to Electricity for Microdistributed Power Applications, accepted in IEEE Transactions on Plasma Science, 2002] may be required to extract stored energy.

Herein, we demonstrate the plasmadynamic conversion (PDC) of plasma thermal to electrical energy from discharge and microwave plasmas as a illustration of power extraction from CA-plasma cells. As in MHD conversion, PDC extracts stored plasma energy directly. Unlike MHD, however, PDC does not require plasma flow. Instead, power extraction by PDC exploits the potential difference established between a magnetized and an unmagnetized electrode [I. Alexeff and D. W. Jones, Phys. Rev. Lett., 15(1965)286] immersed in a plasma to drive current in an external load and, thereby, extract electrical power directly from the stored plasma thermal energy. For the first time, a substantial quantity of electrical power is extracted (up to 0.4 mW in the discharge plasma case and up to 220 mW in the microwave case). This scale-up is concomitant with a like increase in the plasma to neutral density ratio. Further power scale-up to commercially appropriate power levels is now realizable. The engineering relationships learned from these simulation studies can be applied to converting the thermal power from CA-plasmas to electrical power.

Theory

When an isolated (floating) conductor is inserted into a thermal plasma, it is predicted to attain the potential referred to as the floating potential (V_{f}), by the steady, one-dimensional electron equation of motion (EOM) and fixed ions unimpeded by the sheath potential.

$${V}_{f} = {V}_{p} - [ \frac{1}{2} ln ( \frac{2 M}{π m} ) ] \frac{{kT}_{e}}{e} \qquad [ 46 ]$$

Here, Vₚ is the plasma potential, kTₑ is the electron temperature, and M and m are the ion and electron masses, respectively. In the presence of a magnetic field of intermediate strength (i.e. sufficient to magnetize electrons but not ions) and parallel to the surface of the conductor, electron collection at the conductor is substantially reduced and the local floating potential is altered. While a complete and general description is rather involved, sufficient insight into the influence of magnetization can be gained by examining the collection of electron current near the space (plasma) potential [F. F. Chen, Electric Probes, in Plasma Diagnostic Techniques, R. H. Huddlestone and S. L. Leonard, eds., Academic Press, NY, 1965]. This approach is justified since the impediment of electron current to a floating probe results in a modified floating potential, V_{fm}, such that V_{f}<V_{fm}<Vₚ and approaching Vₚ. As magnetization (B) is provided only completely parallel to the probe surface facing the plasma, we consider only diffusive transport of electrons to the probe. In contrast to the situation described by Eq. 46, collisions are now required to allow an electron current to the probe. Current continuity [F. F. Chen, Electric Probes, in Plasma Diagnostic Techniques, R. H. Huddlestone and S. L. Leonard, eds., Academic Press, NY, 1965] dictates that the electron density within one mean collision distance to the probe, n′, is given by

$$\begin{matrix} & & & & & & {n}^{′} = \frac{{n}_{o}}{1 + β} \\ with & & & & & & \\ & & & & & & β = \frac{{A}_{p} \overline{v}}{16 π CD} {( 1 + {Ω}^{2} )}^{1 / 2}\end{matrix}$$

where nₒ is the plasma electron density far from the probe in the bulk plasma, Aₚ is the probe surface area, \overline{v} is the average electron speed, C is the probe capacitance with respect to the surface at infinity with charge density no (taken to be at the plasma-sheath boundary), D is the mass diffusivity in the absence of B, Ω is the electron magnetization parameter (Ω=eB/mvₑₙ), and vₑₙ is the electron-neutral particle collision frequency. Only electron-neutral collisions need to be considered as neutral particles by far dominate the scattering interactions with electrons as the pressures considered here.

Since the probe is aligned parallel to B, the effective collision distance becomes the electron gyro-radius, r_{L}. Since xₛ (sheath thickness)<<r_{L}<<λ (mean free path), collisions may be ignored in the last gyro-step to the probe so that the Boltzmann relation applies

$$n = {n}^{′} exp [ \frac{e}{{kT}_{e}} ( V - {V}_{p} ) ] \qquad [ 47 ]$$

Balancing electron and ion currents, then, for the magnetized floating probe yields

$${V}_{fm} = {V}_{p} - \frac{{kT}_{e}}{2 e} ln ( \frac{2 M}{π m} ) + \frac{{kT}_{e}}{e} ln ( 1 + β ) \qquad [ 48 ]$$

This expression now replaces Eq. 1 in the magnetized as well as unmagnetized case (B=0) since βₒ==β(Ω=0)±0 to include the effect of collisions on electron current in the limit B→0.

Plasmadynamic conversion (PDC) of thermal plasma energy to electricity is achieved by inserting two floating conductors in a plasma, one magnetized, the other unmagnetized. The potential difference between the two conductors (now appropriately referred to as electrodes) is given by the difference in unmagnetized and magnetized floating potential as described by Eq. 48 with βₒ and β, respectfully. Referring to this potential difference as the open circuit PDC voltage, Vₒ, we have

$${V}_{o} = \frac{{kT}_{e}}{e} ln ( \frac{1 + β}{1 + {β}_{o}} )$$

Since β & βₒ>>1, the probe area and capacitance no longer enter the PDC voltage expression, so that

$${V}_{o} = \frac{{kT}_{e}}{2 e} ln ( 1 + {Ω}^{2} ) \qquad [ 49 ]$$

In a strongly magnetized plasma (Q020) at 2 eV, a respectable V_{o,6} V can be expected. The In B dependence at large B is expected from the Boltzmann relation (Eq.47) as the electron density reaching the probe decreases as 1/B for large field strength. I should be noted here that in general the conditions at the magnetized and unmagnetized probe may be different so that even when β & βₒ>>1, the logarithmic term in Eq. 49 may retain the dependencies

$$\frac{β}{{β}_{o}} = \frac{{A}_{p}}{{A}_{{p}_{o}}} \frac{\overline{v}}{{\overline{v}}_{o}} \frac{{C}_{o}}{C} \frac{{D}_{o}}{D} {( 1 + {Ω}^{2} )}^{1 / 2}$$

Where the subscript “o” refers to conditions at the unmagnetized electrode. Increasing the magnetized electrode area or electron thermal speed at the electrode should incur increased PDC voltage, while the same should be expected with a reduction in effective probe capacitance or mass diffusivity near the probe. Modification to the probe surface area though is often the parameter in the most readily controlled by the experimenter. In addition, electrostatic potential difference generated by thermal gradients in the plasma have been neglected here. Placing the electrodes in regions of the plasma at different temperatures can further increase the collection potential [D. Bradley, S. M. A. Ibrahim, and C. G. W. Sheppard, Fourteenth Symposium (International) on Combustion, The Combustion Institute, Pittsburgh, 1973, p.383].

Shorting the PDC electrodes with the load, R_{L}, allows the circuit to be completed, and current and power flow to the external load. The PDC source is necessarily loaded by this action, thereby reducing the source voltage to Vₒ-iR, where R is the internal resistance of the source (i.e. plasma & PDC electrode system). Assigning the loaded PDC voltage as

V_{PDC}=Vₒ−iR

where i=Vₒ/(R+R_{L}), the extracted power is found

$${P}_{PDC} = \frac{{R}_{L}}{{( R + {R}_{L} )}^{2}} {V}_{o}^{2}$$

As expected, the impedance matching condition R=R_{L} determines the peak extracted power

$${P}_{max} = \frac{1}{4 {R}_{L}} {V}_{o}^{2} \qquad [ 50 ]$$

In the Vₒ˜6 V example from above and with R_{L}˜10 kΩ, a maximum extracted power of 0.9 mW can be realized. Attaining 1 W of extracted power from PDC under these plasma conditions requires a source impedance matched to the load at R_{L}˜9 Ω.

Experimental Apparatus

Two separate PDC experiments are described here. In the first, a DC glow type discharge plasma was generated in a 1 in. diameter (OD) by 12 in. glass tube. In the second, a 1.5 kW maximum output power microwave generator was used to generate plasma in a quartz applicator tube of similar dimensions. In both experiments, one magnetized (anode) PDC electrode and one unmagnetized (cathode) electrode was inserted into the main part of the discharge. Open circuit and resistive load tests were performed to obtain Vₒ as well as loaded PDC voltages (V_{PDC}), current, and power as a function of operating and plasma parameters.

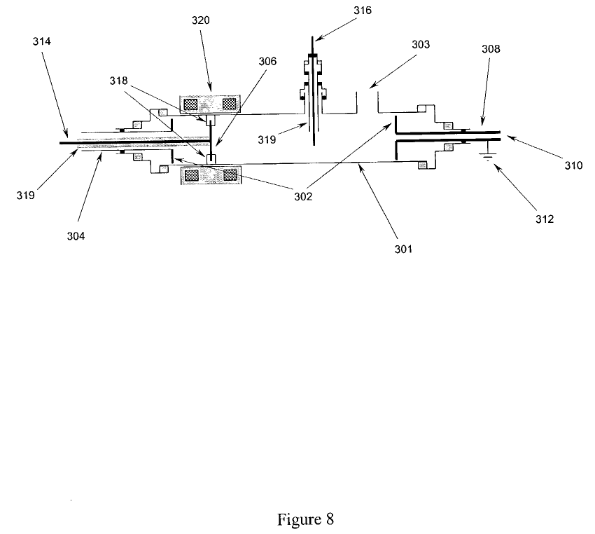

A schematic of the glow discharge tube apparatus is shown in FIG. 8. A gas discharge was initiated in He or Ar at 0.3-3.0 Torr in a 1″ O.D. quartz or borosilicate tube (301) between a set of ¾ in. disk discharge electrodes (302). Gas was introduced though the gas feed port (303). The discharge anode was welded to a ⅜ in. stainless steel [SS] tube (304) to allow concentric access for the PDC anode (306). The discharge cathode was likewise welded to a ⅜ in. SS tube (308) that served both as a vacuum pumping port (310) and electrode. This side of the discharge power delivery was grounded (312) to the experiment platform and power supply ground. The discharge electrodes were separated by 20 cm and are powered by a 600 V, 2 A DC power supply (Xantrex XFR600-2) which produced DC glow plasmas with discharge currents in the range 0.02-150 mA at 300-540 V. Typical discharge operating power for the experiments described here was 10-50 W. A 1 kΩ, 225 W resistor was placed in series with the power supply to limit the discharge current and stabilize the discharge.

The PDC electrodes were fabricated from pure tungsten weld rod of 0.04 in. dia. The collector anode (306) was welded in the shape of a “T” which was then attached to a 12 in. long ⅛ in. dia. SS rod (314) that passed through the vacuum seal and provided electrical connection. The PDC cathode (316) was fabricated in a similar fashion absent the T assembly. The T-anode was positioned via a sliding seal and was made continuously rotatable to allow alignment with the axis of the electromagnet. This ensured field line alignment with the surface of the collector electrode. Teflon end caps (318) were fitted to the T-anode ends to preclude electron collection on the butt ends of the anode rod where field lines intersected the collector. The end caps defined the active collection length of the anode as 1.5 cm and the active collection area as 4.79×10⁻⁵ m². The inactive regions of both PDC electrodes were insulated from other conductors including the plasma with alumina tubes (319).

PDC anode magnetization was provided by a 4 in. dia. Helmholtz type electromagnet coil (320). The coil consisted of 360 turns of 18 gauge magnet wire wound on an aluminum spool. The spool was machined to allow water flow from a chiller at 4-20° C. and 15 1 pm through the spool on the inboard side of the windings. The magnet coil was powered by an 80 V, 37 A (Sorensen DCS 80-37) DC power supply. The coil was indefinitely operated with a steady current of 5 A. The temperature measured by an imbedded K-type thermocouple was found to be less than 100° C. under these conditions. Magnetic induction as a function of coil current was measured to be 67.7 G/A in air. Field uniformity was measured to be±1.5% at 10 mm from the axis along the center plane of the magnet.

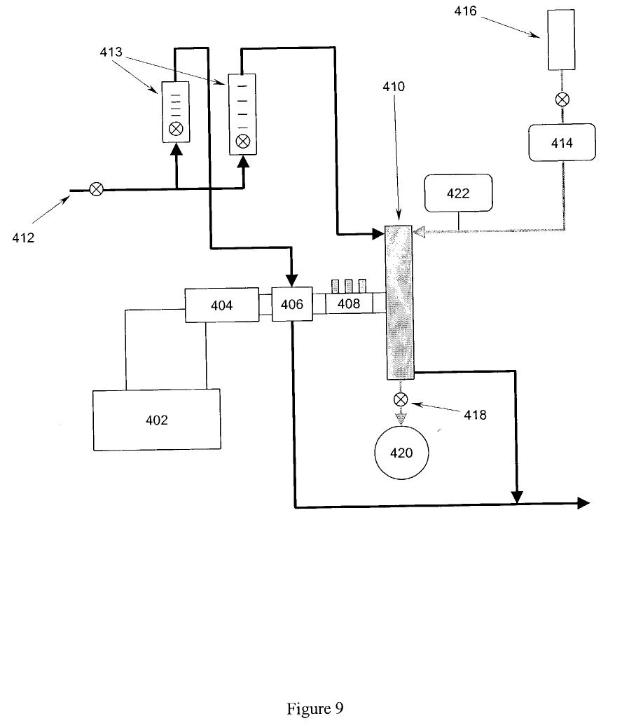

A schematic of the microwave plasma experiment is shown in FIG. 9. This setup comprised a 1.5 kW maximum output power, 2.45 GHz microwave power unit (402), and magnetron generator (404) with circulator and dummy load (406) [Applied Science and Technology, ASTEX-AX2100]; three stub tuner (408) [AX3041]; and downstream plasma applicator (410) [AX7610]. The device was typically operated at 200-1000 W cw with ≦1% reflected power. Tap water (412) at 20° C. and 0.65 1 pm through flow meters (413) was sufficient to cool the applicator and circulator to allow continuous operation at full rated power. A mass flow controller (414) [MKS 1179A] provided steady, regulated He gas (416) flow in the range 0-100 sccm. Device performance, however, was not found to be influenced by changes in the mass flow rate in this flow and pressure regime. A flow rate of 50 sccm was, therefore, used throughout since this choice proved convenient for pressure adjustment. Throttling the vacuum valve (418) before the vacuum pump (420) allowed adjustment of the He gas pressure in the range of 0.2-10 Torr for the experiments discussed here, as monitored by an absolute pressure gauge (422).

The PDC electrodes employed in the gas discharge cell were replicated for use in the nucrowave system with the following exceptions: 1) the T-anode was changed to 0.094 in. dia. SS rod to increase the collection area to 1.125×10⁻⁴ m², and 2) the Teflon end caps were replaced with diamond-tool machined hard Alumina as it is well known that only W, SS, and Alumina are able to survive the high power plasma environment in the microwave system. The same electromagnet set was used in both systems. For the microwave system, the coil separation had to be increased from 1.25 in. to 3 in. resulting in a reduction in the induction calibration to 27.9 G/A in air.

A single-tipped Langmuir probe was employed to measure n and Tₑ in both experiments. The probe consisted of a 0.04 in. dia. W weld rod tip extending 5 mm beyond the end of a short section of Alumina 2-bore with 0.052 in. ID and 0.156 in. OD which was then telescoped inside a 12 in. long section of Alumina single bore, 0.188 in. ID and 0.25 in. OD. Using a separate 600 V, 2A DC power supply, the probe was biased over the current-voltage characteristic from full ion saturation to the exponential electron collection region. Probe bias was manually swept from 30-50 V below to several volts above the floating potential. The collisionless, thin-sheath model was employed for probe data analysis such that the probe current was related to the electron density, n, electron temperature, Tₑ, sheath thickness, xₛ, and plasma potential, Vₚ, by

$${i}_{probe} = en \sqrt{\frac{{kT}_{e}}{M}} A ( 1 + {x}_{s} / {r}_{p} ) \{ \frac{1}{2} {( \frac{2 M}{π m} )}^{1 / 2} exp [ \frac{e}{{kT}_{e}} ( V - {V}_{p} ) ] - exp ( - 1 / 2 ) \}$$

where A is the probe surface area and rₚ is the probe radius. The probe area correction (1+xₛ/rₚ) allows for sheath expansion with increasing bias potential away from the plasma potential. A non-linear least squares filter based on the Levenberg-Marquardt algorithm was used to find the four free parameters sited above. Plasma parameters were found in the range 1-2 eV and 2.5−6.2×10¹⁰ cm⁻³ in the glow discharge experiment, and 2-6.5 eV and 1-3.2×10¹² cm⁻³ in the microwave generated plasmas.

Results and Discussion

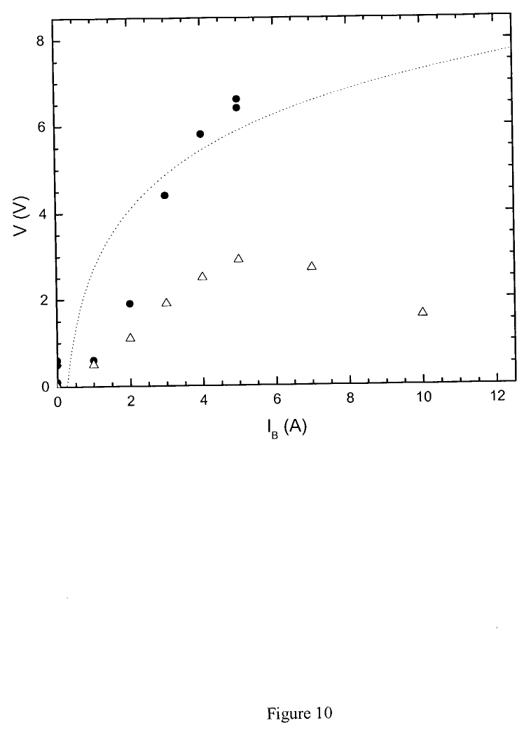

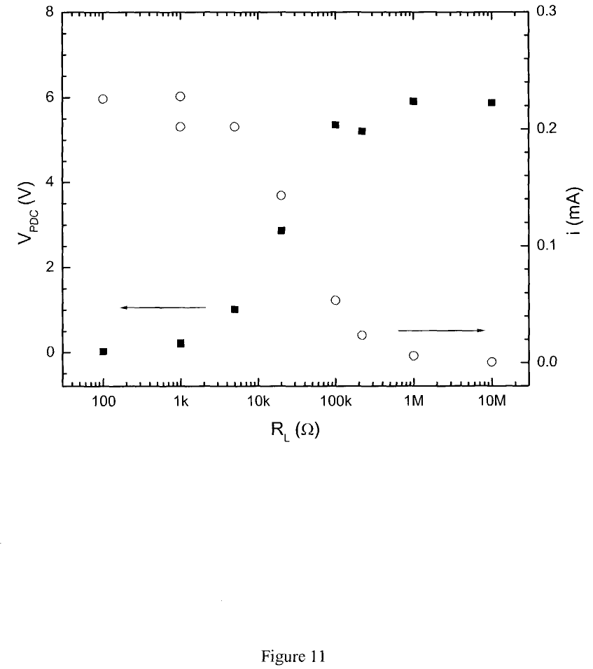

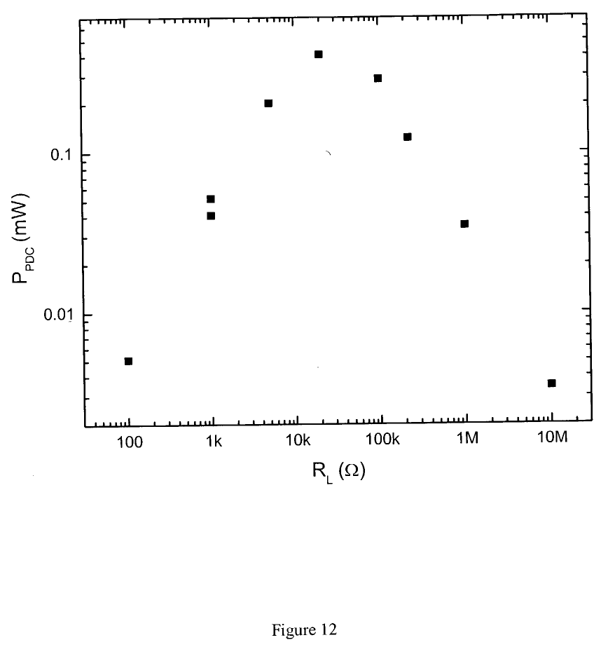

The results from PDC experiments in the glow discharge device are shown in FIGS. 10-14. The nominal operating conditions for the glow discharge tube were 100 mA and ˜350 V discharge current and potential, and 1 Torr He gas fill. In FIG. 10, both open circuit (Vₒ) and PDC (V_{PDC}) voltages are shown as a function of magnet coil current. The evaluation of Eq. 4 with kTₑ1.92 eV and Ω=18.9 at I_{B}=5 A (B=350 G) is also shown for comparison. There is reasonable agreement here with the measured open circuit voltage. The PDC potential with the circuit loaded to 20 kΩ is also shown in FIG. 10. The loaded PDC voltage was found to be consistently ˜½ Vₒ indicating that this load impedance was close to that of the PDC source for the conditions of this experiment. FIGS. 11 and 12 summarize the PDC results obtained by varying the load resistance from 100 Ω to 10 MΩ. In FIG. 11, the PDC voltage was observed to increase steadily from the short circuit condition at R_{L} 0.1 kΩ to voltages approaching the open circuit voltage (>6 V) at R_{L} 0.1 MΩ. The PDC current decrease was found to be consistent with the output voltage trend. The PDC extracted power to load R_{L} is shown in FIG. 12 as a function of load resistance (power-load curve). The power-load curve peaks at the impedance matched condition, ˜20 kΩ, at a maximum extracted power of ˜0.44 mW.

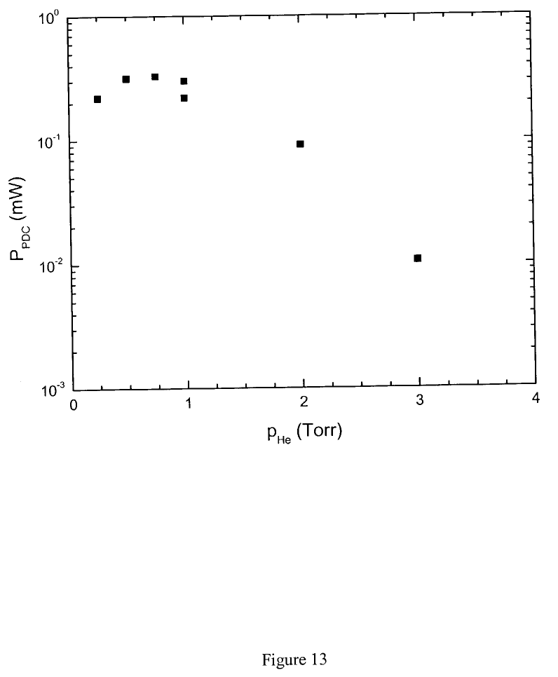

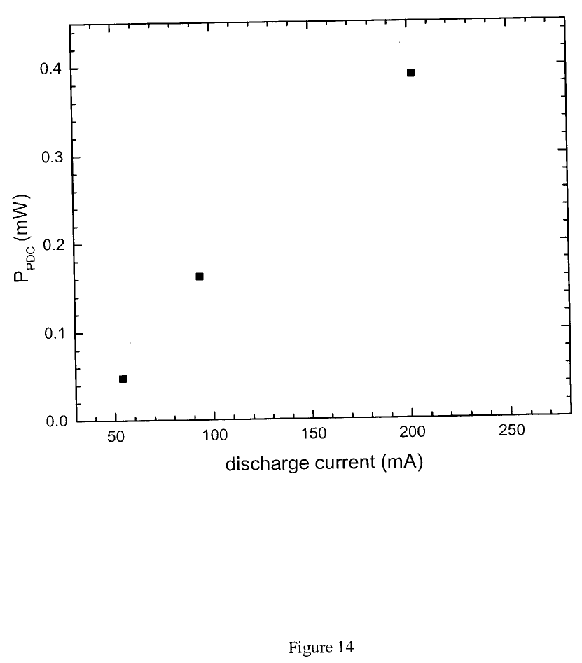

The results of varying the helium fill pressure and discharge current as potential routes to increase the extracted power are shown in FIGS. 13 and 14, respectively. At the load matched condition, R_{L}=R, the peak extracted PDC power should be expected to behave as (Vₒ)²/R. At constant B, ignoring the weak logarithmic dependence in the other contributors to Ω, and considering only electron-neutral collisions, the PDC power scaling predicts

$${P}_{PDC} ∼ \frac{n}{{n}_{n}} {T}_{e}^{3 / 2} \qquad [ 51 ]$$

where nₙ is the neutral atom density in the discharge tube which is proportional to the gas fill pressure. Holding Tₑ constant, P_{PDC} can be expected to scale as

$${P}_{PDC} ∼ \frac{{i}_{discharge}}{{P}_{He}} \qquad [ 52 ]$$

where i_{discharge} is the glow discharge current and p_{He} is the He gas pressure. P_{PDC}increased with increasing glow discharge current and decreasing He gas pressure according to Eq. 52 as shown in FIGS. 13 and 14.

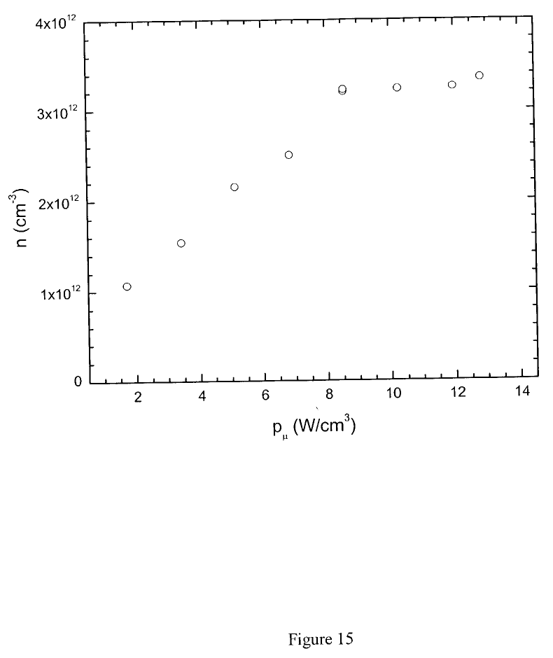

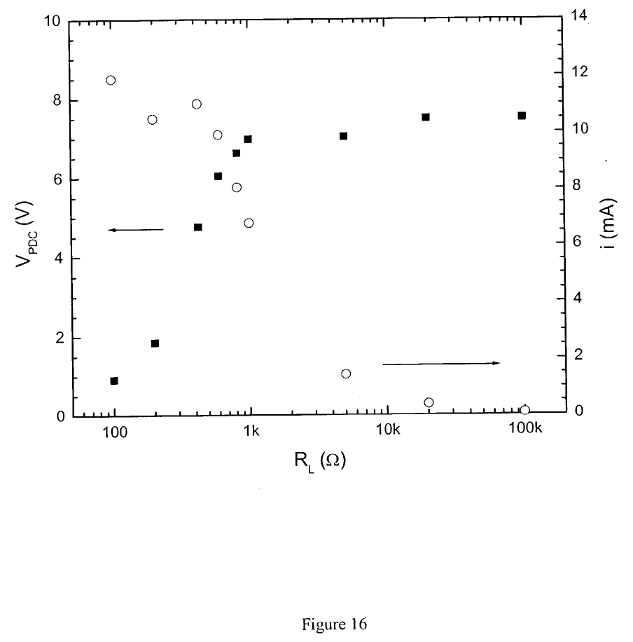

The observed PDC power scaling with discharge current and pressure in the discharge device suggests obvious paths to power scale-up through reduction in the neutral to charge density ratio and concomitant increase in the plasma conductivity. At similar He fill pressure (i.e. ˜1 Torr), the microwave device operated at greatly increased charge density over that in the glow discharge experiment. FIG. 15 shows the results of Langmuir probe electron density measurements in the microwave experiment at 1 Torr He as a function of microwave power density. The result was a density scale-up by almost two orders in magnitude over the glow experiment results. Device and discharge conditions were compared for the two experiments in table 3. A direct application of Eq. 49 predicted an open circuit voltage scale up by ˜33% in the microwave experiment. FIG. 16 shows V_{PDC} and i as functions of load resistance for 1 Torr He microwave plasma at 8.55 W/cm³ input power density. The asymptote in V_{PDC} is the open circuit voltage approaching 7.5 V, an increase of 15.4% over that in the discharge experiment.

TABLE 3
Device and discharge conditions for 1 Torr He.

| | | Microwave |
|---|---|---|
| Parameter | Glow Discharge Experiment | Experiment |
| Aₚ (m²) | 4.79 × 10⁻⁵ | 1.125 × 10⁻⁴ |
| V_{PDC} (V) | 6.5 | 7.5 |
| n (cm⁻³) | 5 × 10¹⁰ | 3 × 10¹² |
| nₙ (cm⁻³) | 3 × 10¹⁶ | 3 × 10¹⁶ |
| Tₑ (eV) | 1.5 | 3.7 |
| Ω | 18.9 | 4.8 |

An estimate of the PDC power scale-up across two experiments is given by combining the predicted potential scaling (Eq. 49) with expected conductivity change based on electron-neutral collisions such that

$$\begin{matrix}\frac{{P}_{{PDC}_{2}}}{{P}_{{PDC}_{1}}} = \frac{{V}_{{PDC}_{2}}}{{V}_{{PDC}_{1}}} \frac{{i}_{2}}{{i}_{1}} = {( \frac{{V}_{{0}_{2}}}{{V}_{{0}_{1}}} )}^{2} \frac{{R}_{1}}{{R}_{2}} \\ = {{( \frac{{kT}_{{e}_{2}}}{{kT}_{{e}_{1}}} )}^{3 / 2} [ \frac{ln ( 1 + {Ω}_{2}^{2} )}{ln ( 1 + {Ω}_{1}^{2} )} ]}^{2} \frac{{( {A}_{p} n )}_{2}}{{( {A}_{p} n )}_{1}} \frac{{n}_{{n}_{1}}}{{n}_{{n}_{2}}}\end{matrix} \qquad [ 53 ]$$

where subscripts 1 & 2 refer to differing devices or conditions, and Aₚ is the PDC electrode active collection area. Comparing the microwave device conditions with those in the glow discharge for the potential ratio found above and the device parameters found for 1 Torr He discharges in the respective devices enumerated in table 3, a PDC power scale-up factor of 158.4 was predicted.

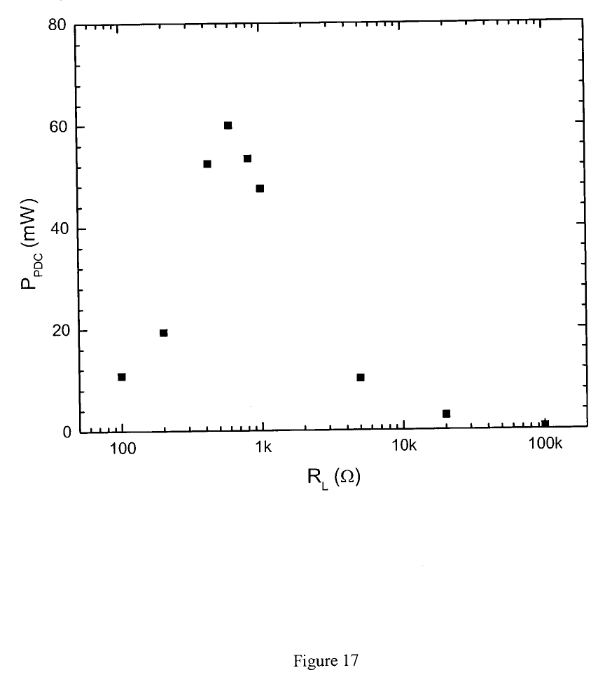

PDC extracted power is shown in FIG. 17 as a function of R_{L} for the microwave discharge conditions of table 3. The optimal (impedance matched) condition in this case was near 600 Ω where the peak PDC power was 60 mW, a factor of 136.4 over that obtained in the glow discharge experiment.

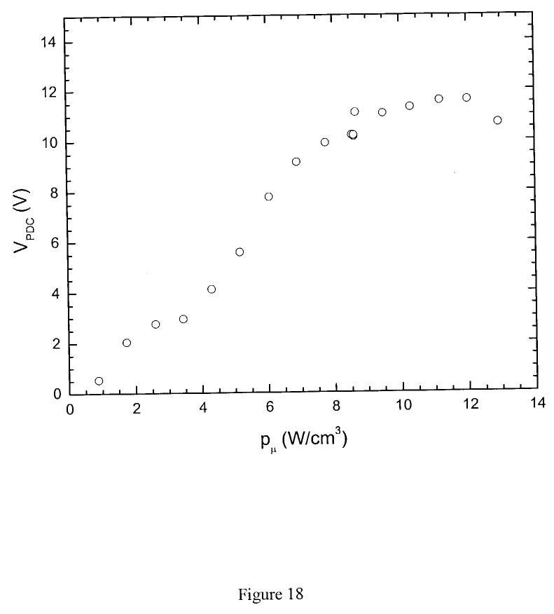

Further improvement has been identified by varying the operating conditions slightly to 0.75 Torr He at 50 sccm. FIGS. 18 & 19 show V_{PDC} and P_{PDC}, respectively, as functions of the microwave power density for this pressure and 600 Ω load. This case demonstrated the maximum observed PDC performance. The PDC power increase to 220 mW was consistent with a measured Tₑ increase to 7 eV over the 1 Torr case (Eq.

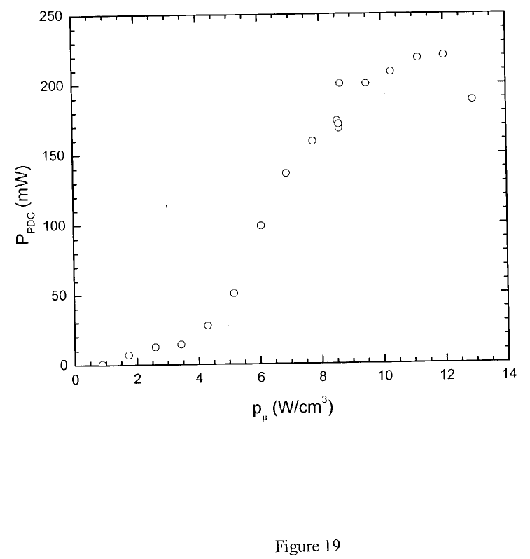

4). Plasma density measured for this enhanced PDC performance case was similar to the 1 Torr case (FIG. 15). The asymptotic behavior in the PDC power with microwave power shown in FIG. 19 is consistent with the leveling off of the plasma conductivity suggested by the density roll-over in FIG. 15.

The conversion efficiency, ε, is estimated as the ratio of conversion to input power densities in the plasma discharge device

$$ϵ = \frac{{p}_{PDC}}{p} \qquad [ 54 ]$$

Here P_{PDC}=P_{PDC}/V_{PDC}, where V_{PDC} represents the plasma volume accessible to PDC power extraction, and p is the input power density to generate and sustain the discharge. (In a CA plasma, the external power input may be reduced substantially below that required in a non-CA plasma.) As the probe's electrostatic influence does not extend beyond the pre-sheath, the relevant interaction volume is defined by the electron mean free path for collisions in this high pressure discharge, and becomes an annular cylindrical volume surrounding the probe extending λ_{mfp} from the probe surface. By way of example for the microwave discharge experiment, at 1 Torr in He the electron λ_{mfp}˜0.082 cm. The PDC accessible plasma volume is then ˜0.124 cm³, making the collection power density ˜1.61 W/cm³ and the conversion efficiency 18.8% for this case.

The Vₒ scaling with electron temperature (Eq. 49) indicates a strong Tₑ dependence in the conversion efficiency, (Eq. 54). Furthermore, the inverse dependence on plasma resistance (ε1/R=Aₚ/ηl) reflects positive probe area scaling and inverse plasma resistivity scaling, indicating clear directions for further performance improvement. Further optimization of PDC power conversion on a single electrode set is in progress as well as power scale-up with multiple electrode sets. A linear power scale-up is anticipated. It is, however, recognized that indefinite increase in electrode number and size relative to that of the discharge is not possible without interfering with plasma conditions. A more detailed efficiency analysis incorporating the affect of electrode perturbation on the plasma should be considered. Discharge seeding by CA-plasma catalysts such as certain alkali and alkali-earth metals [R. L. Mills, J. Dong, and Y. Lu, Int. J. Hydrogen Energy, 25 (2000) 919] to increase charge density may also be employed in an effort to increase conductivity, extracted power, and efficiency, and may also lead to increases in the CA-plasma power.

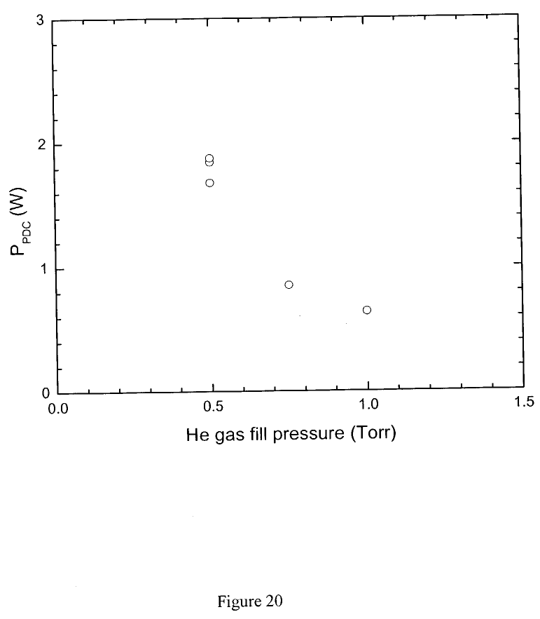

An increase in electrode collection area shows a demonstrable and approximately proportional increase in extracted power. The best ever to-date PDC power extraction of ˜2 W has been achieved with a large area disk electrode (Aₚ˜5.2 cm²) as illustrated in FIG. 20. Here P_{PDC} is shown as a function of He gas filling pressure in the microwave discharge device at 8.55 W/cm³ input power density. Under these conditions the source is matched at R_{L}²⁵⁰ Q. This reduction from the previous 600 Ω is direct indication of increased conduction afforded by the large collection surface. The inverse dependence of P_{PDC} on He fill pressure (∝nₙ) is direct evidence of plasma conductivity increase with nₙ and as well as enhancement with Tₑ which also increases with n, reduction. With a collected power of 1.87 W, the collection power density is 3.6 W/cm³ and the conversion efficiency is 42.1% for this case.

Further Considerations for Optimization

The plasmadynamic converter develops a voltage based on the greater mobility of electrons to an unmagnetized electrode compared to one that is magnetized. The rate at which positive ions as well as electrons collide with each electrode per unit area is equivalent before the application of the field. Consider the open circuit condition after the magnetize field is applied. As discussed previously, due to the Boltzmann relationship (Eq. [47]) the electron density reaching the probe decreases as 1/B for large field strength. In order to maintain steady state, the charge continuity condition must hold wherein the corresponding modified floating potential which approaches the plasma potential must be more positive than the floating potential at the counter electrode. Since the electron flow is retarded, the positive flow must also be retarded. This is due to a positive electric field at the anode which repels the positive ions.

In CA plasmas, the majority of the energy may be with the plasma's energetic positive ion inventory. Since the positive ions have at least a three orders of magnitude lower mobility than that of the electrons, a scheme to extract the component of positive ion energy directly requires the use of electrons. One method to extract energy from the energetic positive ions is to indirectly increase the positive ion current per unit area at the anode compared to the cathode. This may be accomplished by methods such as the injection of electrons at the magnetized or positive electrode, the plasmadynamic anode. The electrons would be retarded from anode by the magnetic field, and the positive current would increase by recombining with the energetic ions. The injection by a method such as boiling off electrons by heating a thoriated tungsten anode, for example, would increase the positive electric field unilaterally. The recombination of the excess electrons with the energetic positive ions extends this field further into the plasma to increase the voltage drop and power collected at the anode. The positive field would extend the Debye length, and the voltage would approach that of the most energetic ions plus the recombination energy of the ion also known as the negative of its ionization potential, IP.

The Post direct or Venetian blind power converter described by Moir and Freis [R. W. Moir, W. L. Barr, and G. A. Carlson, “Direct conversion of plasma energy to electricity for mirror fusion reactors,” Lawrence Livermore Laboratory, IAEA-CN-33/G31, pp. 583-592; R. P. Freis, Nucl. Fus., 13(1973)247] comprises an electrostatic collector which deflects electrons at a first set of negatively biased electrodes, then stops the positive ions at a series of positively biased electrodes to convert the axial kinetic energy into electrical energy. Since the Post device requires that the electrostatic field penetrates the plasma, the physics is similar to electron injection at the plasmadynamic anode. According to Jackson [Jackson, J. D., Classical Electrodynamics, Second Edition, John Wiley & Sons, New York, (1962), p. 497] electrons move in such a way as to screen out the Coulomb field of a test charge in a distance of the order of the Debye length k_{D}⁻¹. The balance between thermal kinetic energy and electrostatic energy determines the magnitude of the screening radius. Numerically

$${k}_{D}^{- 1} = 6.91 {( \frac{T}{{n}_{0}} )}^{1 / 2} cm \qquad [ 55 ]$$

where T is in degrees Kelvin, and nₒ is the number of electrons per cubic centimeter.

The Post device has been studied extensively for converting highly energetic ions (>100 keV) from fusion plasmas into electricity [R. W. Moir, W. L. Barr, and G. A. Carlson, “Direct conversion of plasma energy to electricity for mirror fusion reactors,” Lawrence Livermore Laboratory, IAEA-CN-33/G3-1, pp. 583-592; R. P. Freis, Nucl. Fus., 13(1973)247]. The positive ion energies in CA-plasmas are high compared to those of microwave and glow discharge plasmas (100-200 eV), but too low to be of any practical value in Post converter due to space change limitations at these relatively low energies as discussed previously [R. Mayo, R. Mills, M. Nansteel, “On the Potential of Direct and MHD Conversion of Power from a Novel Plasma Source to Electricity for Microdistributed Power Applications”, accepted in IEEE Transactions on Plasma Science, 2002].

However, charge injection at a plasmadynamic electrode avoids the space charge limitation wherein the ion separation is on a very small scale. In an exemplary CA-plasma, the ion density is 10¹² ions/cm³, and the positive ion temperature corresponding to 150 eV is 3.5×10⁶ K which corresponds to a Debye length of

$${k}_{D}^{- 1} = 6.91 {( \frac{T}{{n}_{0}} )}^{1 / 2} cm = 1.3 \times {10}^{- 2} cm = 130 µm \qquad [ 56 ]$$

This length is less than the positive ion gyro-radius and about the mean free path for electron-positive ion collision-recombination. Thus, additional power may converted directly from the positive ions.

The direct power converter described by Timofeev and Glagolev [A. V. Timofeev, Sov. J. Plasma Phys., 4(1978)464; V. M. Glagolev and A. V. Timofeev, Plasma Phys. Rep., 19(1993)745] relies on charge injection to drifting separated positive ions in order to extract power from a plasma. This charge drift converter is described later. It comprises a magnetic field gradient in a direction transverse to the direction of a source of a magnetic flux B and a source of magnetic flux B having a curvature of the field lines. In both cases, drifting negatively and positively charged ions move in opposite directions perpendicular to plane formed by B and the direction of the magnetic field gradient or the plane in which B has curvature. In each case, the separated ions generate a voltage at opposing capacitors that are parallel to the plane with a concomitant decrease of the thermal energy of the ions. The electrons are received at one electrode and the positive ions are received at another. Since the mobility of ions is much less than that of electrons, Timofeev proposes electron injection directly or by boiling them off from a heated electrode. The power loss given by Timofeev [A. V. Timofeev, Sov. J. Plasma Phys., 4(1978)464] is small, and the corresponding voltage drop is given by the Langmuir-Child equation.

$$\begin{matrix}J = \frac{4 ϵ}{9 {d}^{2}} \sqrt{\frac{2 e}{m}} {V}^{3 / 2} & [ 57 a ] \\ V = {( \frac{9 {d}^{2}}{4 ϵ} )}^{2 / 3} {( \frac{m}{2 e} )}^{1 / 3} {J}^{2 / 3} & [ 57 b ]\end{matrix}$$

where J is the cathode electron injection current, m is the electron mass, d is the distance the electron travels before recombination with a positive ion, and ε is the permittivity. The same applies in the case of electron injection in a plasmadynamic converter wherein d is approximately the Debye length given by Eq. [56]. For a current of 0.01 A, d given by Eq. [56], and ε given by the permittivity of vacuum, the voltage drop given by Eq. [57b] is

$$\begin{matrix}V = {( \frac{9 {d}^{2}}{4 ϵ} )}^{2 / 3} {( \frac{m}{2 e} )}^{1 / 3} {J}^{2 / 3} \\ = {( \frac{9 {( 1.3 \times {10}^{- 4} m )}^{2}}{4 ( 8.85 \times {10}^{- 12} {Fm}^{- 1} )} )}^{2 / 3} {( \frac{9.11 \times {10}^{- 31} kg}{2 ( 1.60 \times {10}^{- 19} C )} )}^{1 / 3} {( 0.1 A )}^{2 / 3} \\ = 8.07 \times {10}^{- 3} V\end{matrix} \qquad [ 58 ]$$

The corresponding power drop is the plasmadynamic current times this voltage which is projected to be negligible, ≈1 m W for a plasmadynamic current of 0.1 A.

Cross electric and magnetic fields and ions moving across gradient fields may develop during the operation of the plasmadynamic converter, but these effects are overwhelmed by collisions as discussed previously [R. Mayo, R. Mills, M. Nansteel, “On the Potential of Direct and MHD Conversion of Power from a Novel Plasma Source to Electricity for Microdistributed Power Applications”, accepted in IEEE Transactions on Plasma Science, 2002].

The effect of the injection of electrons at the anode gives rise to a new term in Eq. [48] corresponding to the contribution from the ions. In the case that the magnetized and unmagnetized electrodes are identical and the plasma conditions are matched, Eq. [48] with an ion contribution becomes

$$\begin{matrix}{V}_{fm} = {V}_{p} - \frac{{kT}_{e}}{2 e} ln ( \frac{2 M}{π m} ) + \frac{{kT}_{e}}{e} ln ( 1 + {β}_{e} ) + \frac{{kT}_{i}}{e} ln ( 1 + {β}_{i} ) - \\ {( \frac{9 {d}^{2}}{4 ϵ} )}^{2 / 3} {( \frac{m}{2 e} )}^{1 / 3} {J}^{2 / 3} + IP\end{matrix} \qquad [ 59 ]$$

where Tᵢ is the ion temperature, βₑ is the term of Eq. [48] corresponding to electrons, βᵢ is the term of Eq. [48] corresponding to ions, and IP is the term corresponding to electron-ion recombination energy.

Additional increases in the plasmadynamic voltage and extracted power from ions as well as electrons may be achieved by engineering differences between each parameter of Eq. [48] at the cathode versus the corresponding parameter at the anode. For example, at least one of the areas of the electrodes Aₑ, the capacitances the electrodes C, the average electron or ion velocity \overline{v}, and each diffusivity D may be different at the cathode versus the anode. The open circuit voltage may be increased with contributions from ions as well as electrons according to these differences as given by the modified Eq. [49]

$${V}_{0} = \frac{{kT}_{e}}{2 e} ln ( \frac{{A}_{e , c} {\overline{v}}_{e , c} {C}_{e , a} {D}_{e , a}}{{A}_{e , a} {\overline{v}}_{e , a} {C}_{e , c} {D}_{e , c}} ( 1 + {β}_{e} ) ) + \frac{{kT}_{i}}{e} ln ( \frac{{A}_{i , c} {\overline{v}}_{i , c} {C}_{ie , a} {D}_{i , a}}{{A}_{i , a} {\overline{v}}_{i , a} {C}_{i , c} {D}_{i , c}} ( 1 + {β}_{i} ) ) - {( \frac{9 {d}^{2}}{4 ϵ} )}^{2 / 3} {( \frac{m}{2 e} )}^{1 / 3} {J}^{2 / 3} + IP \qquad [ 60 ]$$

where the subscripts i, e, c and a correspond to ions, electrons, the cathode, and the anode, respectively. Then, the open circuit voltage can be increased by increasing the relative cathode area, increasing the relative average electron and ion velocities at the cathode, increasing the relative capacitance at the anode, and increasing the relative ion and electron diffusivities at the anode. The selection of the average velocity and diffusivity may be achieved by locating the electrode in the cell to select for local plasma conditions.

Since the ions are not magnetized, the rate at which ions strike identical electrodes are equal, and no ion voltage contribution is expected; however, independent of the effect of injecting electrons at the cathode, a difference in the terms given in Eq. [56] would give rise to a cathode contribution to the plasmadynamic open circuit voltage. And, the injections of electrons only at the cathode may also be considered as an increase in the cathode area, an increase in the electron velocity, a decrease in the cathode capacitance, and a decrease in the electron diffusivity at the cathode. The effect of changes in the parameters of Eq. [60] on the plasmadynamic power output is under study as the device is being scaled-up to higher powers.

Jackson [J. D. Jackson, Classical Electrodynamics, Second Edition, John Wiley & Sons, New York, (1962), pp. 584-588] shows that if charged particles move through regions where a magnetic field gradient exists in a direction transverse to the direction of a magnetic flux B, drifting negatively and positively charged ions move in opposite directions perpendicular to a plane formed by B and the direction of the magnetic field gradient. The gradient drift velocity v_{G} of the guiding center of gyration of the ions about the magnetic flux B is given by (cgs units)

$${v}_{G} = \frac{{ω}_{B} {a}^{2}}{2 {B}^{2}} ( B \times {∇}_{⊥} B ) \qquad [ 61 ]$$

where

$${ω}_{B} = \frac{{eB}_{0}}{γ m c}$$

is the cyclotron frequency and a is the maximum radius of the cyclotron orbit.

Jackson [J. D. Jackson, Classical Electrodynamics, Second Edition, John Wiley & Sons, New York, (1962), pp. 584-588] further shows that if charged particles move through regions where a magnetic flux B having a curvature of the field lines exits, drifting negatively and positively charged ions move in opposite directions perpendicular to the plane in which B has curvature. The curvature drift velocity v_{c} of the guiding center of gyration about the magnetic flux B is given by (cgs units)

$${v}_{G} = \frac{{v}_{‖}^{2}}{{ω}_{B} R} ( \frac{R \times {B}_{0}}{{RB}_{0}} ) \qquad [ 62 ]$$

where ω_{B} is the cyclotron frequency and v_{∥} is the velocity parallel to the magnetic flux B. The direction of drift is specified by the vector product, in which R is the radius vector from the effective center of curvature to the position of the charge. The sign in Eq. [62] is appropriate for positive charges and is independent of the sign of v_{∥}. For negative particles the opposite sign arises from Ω_{B}.

For regions of space in which there are no currents, the gradient drift velocity v_{G} (Eq. [61]) and the curvature drift velocity v_{c} (Eq. [62]) can be combined in a simple form since Δ×B=0. For a two-dimensional field having curvature,

$$\frac{{∇}_{⊥} B}{B} = - \frac{R}{{R}^{2}} \qquad [ 63 ]$$

Then, for a two-dimensional field, the sum of v_{G} and v_{C} is the total drift velocity v_{D} given by (cgs units)

$${v}_{D} = \frac{1}{{ω}_{B} R} ( {v}_{‖}^{2} + \frac{{v}_{⊥}^{2}}{2} ) ( \frac{R \times B}{RB} ) \qquad [ 64 ]$$

where v_{⊥}=ω_{B}a is the transverse velocity of gyration.

At least one of the gradient drift velocity v_{G} (Eq. [61]) and the curvature drift velocity v_{C} (Eq. [62]) can be used to separate ions and convert the thermal energy to a voltage with a corresponding electric field which is perpendicular to the magnetic flux B having a perpendicular gradient or curvature. Thus, the energy is converted in crossed imposed magnetic and resultant electric fields. The magnetic flux B perpendicular to the electric field prevents the charges from flowing along the electric field and canceling it.

The charge drift power converter comprises at least one of a source of a azimuthal magnetic flux B that has a magnetic field gradient in a redirection transverse to the direction of B and an azimuthal magnetic flux B has an azimuthal curvature. The azimuthal field is constant in the z-direction. A flow of ions may be received at a plasma injection port of the charge drift power converter. The injection port may comprise an upper capacitor plate and a lower capacitor plate with a passage for ions diverted in the z-direction. The capacitor plates at the injection port may be at zero potential. In both the case of the gradient field and the curved field, the thermal energy of the plasma is converted into electrical energy as the charged particles drift in crossed fields: an inhomogeneous magnetic field and an electric field perpendicular to the magnetic field. The ions move across the gradient or curved field due to the \overline{E}×\overline{B} drift velocity affected by the crossed fields.

The motion of a charged particle in crossed electric and magnetic fields with the electric field E less that the magnetic field B described by Jackson [J. D. Jackson, Classical Electrodynamics, Second Edition, John Wiley & Sons, New York, (1962), pp. 582-584] is gyration around the magnetic field with a uniform drift at velocity u in the direction perpendicular to both the perpendicular electric and magnetic fields. The drift velocity u (cgs units) is given by

$$u = c \frac{( E \times B )}{{B}^{2}} \qquad [ 65 ]$$

In the case that E>B, the electric field is so strong that the particle is continually accelerated in the direction of E and its average energy continues to increase with time [J. D. Jackson, Classical Electrodynamics, Second Edition, John Wiley & Sons, New York, (1962), pp. 582-584].

In the charge drift power converter, the drifting negatively and positively charged ions move in opposite directions perpendicular to plane formed by B and the direction of the magnetic field gradient or the plane in which B has curvature. In each case, the separated ions generate a voltage at opposing capacitors that are parallel to the plane with a concomitant decrease of the thermal energy of the ions. The electric field is from the deflected ions since it is determined by the maximum energy on the particles.

$$\begin{matrix}e φ ( z ) = \frac{1}{2} {mv}^{2} & [ 66 ] \\ E = \frac{φ ( z )}{l} = \frac{\frac{1}{2} {mv}^{2}}{el} & [ 67 ]\end{matrix}$$

where I is the distance between the capacitor plates. Jackson [J. D. Jackson, Classical Electrodynamics, Second Edition, John Wiley & Sons, New York, (1962), pp. 582-584] shows that the curvature drift velocity is equivalent to that of the \overline{E}×\overline{B} drift velocity of the magnetic field and an effective central electric field given by

$${E}_{eff} = \frac{γ m}{e} \frac{R}{{R}^{2}} {v}_{‖}^{2} \qquad [ 68 ]$$

that gives rise to a centrifugal acceleration of magnitude

$$\frac{{v}_{‖}^{2}}{R}$$

of the guiding center. From Eq. [68] and Eq. [65], the curvature drift velocity is

$${v}_{c} ≅ c \frac{γ m}{e} {v}_{∥}^{2} \frac{R \times {B}_{0}}{{R}^{2} {B}_{0}^{2}} \qquad [ 69 ]$$

With the definition of ε_{B} as

$${ω}_{B} = \frac{{eB}_{0}}{γ m c} \qquad [ 70 ]$$

the curvature drift may be written

$${v}_{c} = \frac{{v}_{∥}^{2}}{{ω}_{B} R} ( \frac{R \times {B}_{0}}{{RB}_{0}} ) \qquad [ 71 ]$$

An equivalent analysis can be made for the gradient drift velocity. From Eq. [68], Eq. [71], and Eq. [61], the combined effective electric field is

$${E}_{eff} = \frac{γ m}{e} \frac{R}{{R}^{2}} ( {v}_{∥}^{2} + \frac{{v}_{⊥}^{2}}{2} ) \qquad [ 72 ]$$

The magnitude of the electric field of Eq. [72] is the maximum magnitude of the z-directed electric field formed by the separating ions in order that E<B, according to Eq. [65]. The application of an additional electric field would result in E>B wherein the electric field is so strong that the particle is continually accelerated in the direction of E and its average energy continues to increase with time. In the case that E<B, according to Eq. [65] the magnetic flux B perpendicular to the electric field corresponding to the voltage prevents the charges from flowing along the electric field and canceling the electric field. The plasma may flow from the converter through the plasma ejection system after its thermal energy has been converted to electrical energy.

The flow of ions is received at a plasma injection port of the charge drift power converter. And, the thermal energy of the plasma injected in an azimuthal magnetic field which falls off in the radial direction and a vertical electric field between two capacitor plates is converted into electrical energy as the charged particles drift in crossed fields. The charged particles drift away from the center of the converter in the crossed fields with a concomitant separation of the ions: the positive ions are displaced upward and the electrons are displaced downward according to the equation of the drift motion which may be written as

$${v}_{G} = \frac{c}{e} [ ∇ ( \frac{{ϵ}_{∥}}{{H}^{2}} ) H ] \qquad [ 73 ]$$

where

ε_{™}=ε−eφ(z)−μH(r) [74]

φ(z) is the electric potential, H(r) is the magnetic field,

$$μ = \frac{{ϵ}_{⊥}}{H}$$

is the magnetic moment, ε is the total energy of the particle, and the subscripts give the direction with respect to the magnetic field which is assumed to be irrotational. From Eq. [73], the quantity

$$C = \frac{{ϵ}_{∥}}{{H}^{2}}$$

should remain constant in drift motion. In this case

ε=eφ(z)+μH(r)+CH²(r) [75]

The second term of Eq. [75] gives the energy of the transverse motion,

$$\frac{m {v}_{⊥ 0}^{2}}{2} ( \frac{H ( r )}{H ( {r}_{0} )} ) \qquad [ 76 ]$$

The third term of Eq. [75] gives the energy of the longitudinal motion,

$$\frac{m {v}_{∥ 0}^{2}}{2} {( \frac{H ( r )}{H ( {r}_{0} )} )}^{2} \qquad [ 77 ]$$

Since the total energy of the particle is conserved, the drift motion in the region of the weaker magnetic field should result in the conversion of thermal energy of the particle into electric field energy; the conversion is more efficient for longitudinal energy than for the transverse energy. The fraction of the converted energy (the recovery factor) η is determined by the ratio

$$α ( r ) = \frac{H ( r )}{H ( {r}_{0} )} \qquad [ 78 ]$$

and is given by

$$η ( r ) = 1 - α ( r ) \frac{{ϵ}_{⊥ 0}}{{ϵ}_{⊥ 0} + {ϵ}_{∥ 0}} - {α}^{2} ( r ) \frac{{ϵ}_{∥ 0}}{{ϵ}_{⊥ 0} + {ϵ}_{∥ 0}} \qquad [ 79 ]$$

In the case that the magnetic field decreases by a factor of three, and the initial kinetic energy is primarily in the parallel direction, the efficiency may be high (e.g. 90%).

Scale Up

In an embodiment of the plasmadynamic power converter, the magnetized electrode, defined as the anode, comprises a magnetized pin wherein the field lines are substantially parallel to the pin. Any flux that would intercept the pin ends on an insulator. An array of such pins may be used to increase the power converted. The at least one counter unmagnetized electrode defined as the cathode is electrically connected to the one or more anode pins through an electrical load.

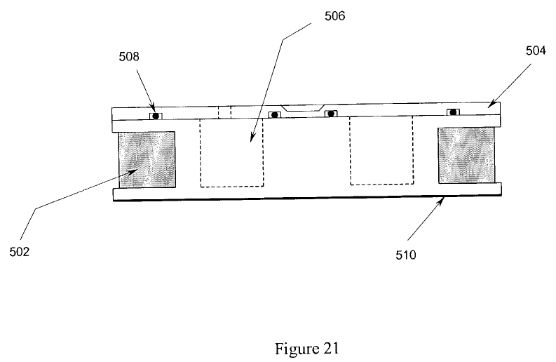

FIG. 21 shows a schematic of a high power DC electromagnet that may be used to magnetize PDC electrodes. Cu magnet wire [340 turns of 20 gauge wire] (502) are wound around an A1 spool (504). A baffled water channel (506) is cut in the A1 spool to provide active water cooling for high current steady operation (up to 5 A). Viton O-rings (508) provide seals to prevent water leakage, and a neoprene compression cushion (510) allows seating on a hard surface.

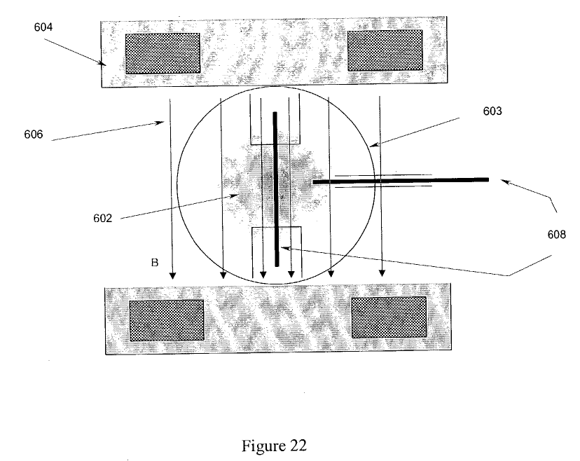

One embodiment of a high power PDC converter assembly is illustrated in FIG. 22. The plasma (602) is shown by shading and resides in vessel (603). This assembly comprises electro- or permanent magnets (604) to produce magnetic field (606) and PDC electrodes (608).

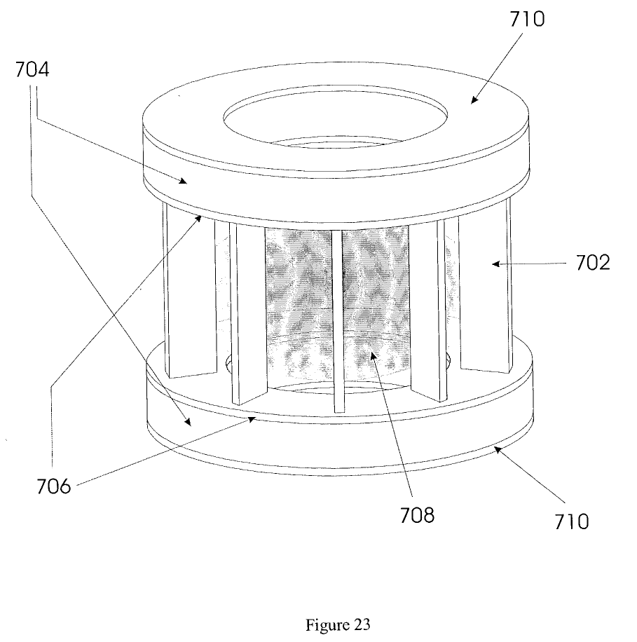

Scale up to multiple electrodes is shown in FIG. 23 which comprises an array of 10 magnetized electrodes (702) wherein each electrode spans permanent magnetic pole pieces (704) of opposite polarity with flux concentrators (706) to guide the field lines parallel to the magnetized electrodes. The plasma (708) is contained in at least the volume inside of the array of magnetized electrodes. The counter unmagnetized electrodes (710) are located at the ends of the assembly as shown in FIG. 23. The magnetized electrodes may be electrically connected to unmagnetized counter electrodes through an electrical load.

In another embodiment, magnetized electrode called the anode in this disclosure is heated to boil off electrons which are much more mobile than the ions. The electrons may be trapped by the magnetic field lines or may recombine with ions to give rise to a greater positive voltage at the anode. Preferably energy is extracted from the energetic positive ions as well as the electrons.

### CONCLUSIONS

Glow discharge and microwave plasma generation sources that provide reproducible, stable plasmas with power densities on the order of those of CA-plasmas were used to characterize plasmadynamic power conversion. The PDC generation of electrical power was experimentally demonstrated at the ˜2 W level in laboratory plasma devices for the first time. Glow discharge and microwave plasma sources were operated at power levels up to 50 W and 11.97 W/cm³, respectively. In a glow discharge of 1 Torr He fill with Tₑ˜9 eV and n˜2.8×10¹⁰ cmm⁻³, PDC open circuit voltages were shown to increase with applied field strength (0-350 G) up to 6.5 V. These results were demonstrated to be in agreement with a model describing electron current retardation to a magnetized electrode. Power-load curves identify the impedance matching condition at 20 kΩ, for which the peak PDC extracted power is 0.44 mW.

Electron and neutral particle density scaling experiments for P_{PDC} reveal the strong dependence on plasma conductivity. Power scale-up was demonstrated in a microwave device which generated plasmas in 1 Torr He with T,3.7 eV and n˜3.2×10¹² cm⁻³. The charge density, electron temperature, and electrode collection area scale-up were the dominant affects in a PDC power scale-up by a factor of almost 140 over the glow discharge PDC results. PDC extracted power to 60 mW was found in a 1 Torr He microwave discharge at 8.55 W/cm³ and 600 Ω load match. The reduced load match was itself evidence of a greatly enhanced plasma conductivity. P_{PDC} to ˜200 mW was found in the microwave experiment at 8.55 W/cm³ and 0.75 Torr He. Peak output performance to 220 mW PDC power was obtained at 11.97 W/cm³ microwave input for this case. Power scale up was achieved by a further increase in electrode collection area so that the best ever to-date PDC power extraction of 2 W has been achieved with a large area disk electrode (A_{P}˜5.2 cm²). Under these conditions the source is matched at R_{L}250 Ω and the collection power density is 3.6 W/cm³ making the conversion efficiency 42.1% for this case.

Plasmadynamic conversion may be optimized for high power and efficiency. The system is simple with projected costs on the order of 1% those of fuel cells. The implications for microdistributed power are profound. Autonomous, chemically driven, power producing plasma units outfitted with plasmadynamic collection devices are envisioned which could enable microdistributed electrical and motive power applications without infrastructure requirements other than those of its manufacture and distribution. In commercial power applications, an array of 50×50 such anode pins would produce over 500 W of electrical power. Since the power is a function of the ion energy, much greater extracted power per anode is anticipated from CA-plasma sources with ion energies greater than 10 times those achieved in a microwave plasma source.

1. A method of converting plasma energy into electricity comprising:
forming a low pressure plasma at a pressure less than atmospheric; and
using a converter to convert the plasma energy into electricity.

2. A method according to claim 1, wherein the plasma is formed at a pressure less than 700 torr.

3. A method according to claim 1, wherein the converter comprises at least one set of electrodes and plasma flow perpendicular to crossed electric and magnetic fields with a source of magnetic field that provides a uniform parallel magnetic field.

4. A method according to claim 3, wherein the source of magnetic field comprises at least one selected from the group consisting of solenoidal magnets, helmholtz magnets, and permanent mangets.

5. A method according to claim 3, wherein the converter exploits magnetic field gradients to enhance power extraction or efficiency.

6. A method according to claim 3, wherein the converter exploits particle drifts to enhance power extraction or efficiency.

7. A method according to claim 3, wherein the converter exploits the hall effect to enhance power extraction or efficiency.

8. A method according to claim 3, wherein the converter utilizes an multiplicity of electrodes to enhance power extraction or efficiency.

9. A method according to claim 3, wherein the electrodes are in the shape of disks, T's, or rods.

10. A method according to claim 1, wherein the converter comprises at least one set of electrodes and plasma flow into a region containing electric and magnetic fields with a source of magnetic field that provides uniform parallel magnetic field.

11. A method according to claim 10, wherein the source of magnetic field comprises at least one selected from the group consisting of solenoidal magnets, helmholtz magnets, and permanent mangets.

12. A method according to claim 10, wherein the converter exploits magnetic field gradients to enhance power extraction or efficiency.

13. A method according to claim 10, wherein the converter exploits particle drifts to enhance power extraction or efficiency.

14. A method according to claim 10, wherein the converter exploits the hall effect to enhance power extraction or efficiency.

15. A method according to claim 10, wherein the converter utilizes an multiplicity of electrodes to enhance power extraction or efficiency.

16. A method according to claim 10, wherein the electrodes are in the shape of disks, T's, or rods.

17. A method according to claim 1, further comprising the step of boiling off electrons using thoriated tungsten or the like to increase collection and power.

18. A method according to claim 1, further comprising the step of discharge seeding the plasma with alkali or alkali earth metals.

19. A method according to claim 1, wherein the converter comprises at least one set of electrodes and a magnetic field parallel to one member of each set of electrodes with a source of magnetic field that provides a uniform parallel magnetic field.

20. A method according to claim 19, further comprising the step of boiling off electrons using thoriated tungsten or the like to increase collection and power.

21. A method according to claim 19, further comprising the step of discharge seeding the plasma with alkali or alkali earth metals.

22. A method according to claim 1, wherein the converter comprises at least one set of electrodes and a magnetic field parallel to one member of each set of electrodes with a source of magnetic field that provides a uniform parallel magnetic field.

23. A method according to claim 22, wherein the electrodes are in the shape of disks, T's, or rods.
